(19) United States
(12) Patent Application Publication
(10) Pub. No.: US 2010/0038357 A1
(43) Pub. Date: Feb. 18, 2010

(54) PTC RESISTOR

(75) Inventors: Hirosi Fukuda, Osaka (JP); Katsuhiko Uno, Osaka (JP); Takahito Ishii, Osaka (JP); Keizo Nakajima, Osaka (JP); Akihiro Umeda, Osaka (JP)

Correspondence Address: Brinks Hofer Gilson & Lione/Panasonic, P.O. Box 10395, Chicago, IL, 60610, US

(73) Assignee: Panasonic Corporation, Kadoma-shi (JP)

(21) Appl. No.: 12/521,820

(22) PCT Filed: Jan. 22, 2008
(86) PCT No.: PCT/JP2008/051148

§ 371 Date: Jun. 30, 2009

(30) Foreign Application Priority Data
Jan. 22, 2007 (JP) 2007-010995
Jan. 22, 2007 (JP) 2007-010997
Jan. 22, 2007 (JP) 2007-010998
Jan. 22, 2007 (JP) 2007-010999
Jan. 22, 2007 (JP) 2007-011000
Feb. 11, 2007 (JP) 2007-010996
Jun. 27, 2007 (JP) 2007-168439

(51) Int. Cl. H05B 3/10

(52) U.S. Cl. 219/553

(57) ABSTRACT

A PTC resistor according to the present invention comprises at least one PTC composition which comprises at least one resin and at least two conductive materials. The at least two conductive materials comprises at least two conductive materials different from each other. The at least one PTC composition may comprise a first PTC composition which comprises a first resin and at least one first conductive material and a second PTC composition which is compounded with the first PTC composition and comprises a second resin and at least one second conductive material. The at least one first conductive material is at least partially different from the at least one second conductive material. One of the first resin and the second resin may comprise a reactant resin and a reactive resin which is cross-linked with the reactant resin. The PTC resistor may comprise a flame retardant agent. The PTC resistor may comprise a liquid-resistant resin.

### TECHNICAL FIELD

The present invention relates to a resistor having a PTC characteristic, and in particular, the present invention relates to a polymer resistor composition with an excellent PTC characteristic, and a highly reliable sheet heating element using this polymer resistor composition. The sheet heating element has a characteristic of being so highly flexible that it can be mounted on a surface of any shape of an appliance.

### BACKGROUND ART

PTC characteristic refers to a characteristic such that when the temperature rises, resistance rises with it. A sheet heating element having such a PTC characteristic has self-temperature control of the heat which it emits. Heretofore, a resistor was used in the heat-emitting member of such a sheet heating element. This resistor was formed from a resistor ink composed of a base polymer and a conductive material dispersed in a solvent.

This resistor ink is printed on a base material forming a heating element. The ink is dried, and then baked to form a sheet-shaped resistor (e.g., see Patent Reference 1, Patent Reference 2, and Patent Reference 3). This resistor emits heat by conducting electricity. A conductive material used in this type of resistor is typically carbon black, metal powder, graphite, and the like. A crystalline resin is typically used as a base polymer. A sheet heating element formed from such materials exhibits a PTC characteristic.

FIG. 1A is a plan view of a prior art sheet heating element described in Patent Reference 1. For the sake of description, the drawing gives a transparent view into the internal structure of the heating element. FIG. 1B is a sectional view along the line 1B-1B in FIG. 1A. As shown in FIG. 1A and FIG. 1B, a sheet heating element 10 is formed from a substrate 11, a pair of electrodes 12, 13, a polymer resistor 14, and a cover material 15. The electrodes 12, 13 form a comb-like shape. The substrate 11 is a material with electrical insulating properties, and is formed from a resin and is, for instance, a polyester film.

The electrodes 12, 13 are formed by printing a conductive paste such as a silver paste on the substrate 11 and then allowing it to dry. The polymer resistor 14 makes electrical contact with the comb-shaped electrodes 12, 13, and is electrically fed by these electrodes. The polymer resistor 14 has a PTC characteristic. The polymer resistor 14 is formed from a polymer resistor ink, and this ink is printed and dried in a position to make electrical contact with the electrodes 12, 13 on the substrate. The cover material 15 is formed from the same type of material as the substrate 11, and protects the electrodes 12, 13 and the polymer resistor 14 by covering them.

In cases where a polyester film is used as the substrate 11 and the cover material 15, a hot-melt resin 16 such as modified polyethylene is caused to adhere to the cover material 15 in advance. Then, while applying heat, the substrate 11 and the cover material 15 are compressed. Accordingly, the substrate 11 and the cover material 15 are joined. The cover material 15 and the hot-melt resin 16 isolate the electrodes 12, 13 and the polymer resistor 14 from the external environment. For this reason, the reliability of the sheet heating element 10 is maintained for a long time.

FIG. 2 shows an abbreviated sectional view of the structure of a device which applies the cover material 15. As shown in the drawing, a laminator 22 formed with two hot rollers 20, 21 performs thermal compression. In this process, the substrate 11 on which the electrodes 12, 13 and the polymer resistor 14 are formed in advance, and the cover material 15 to which the hot-melt resin 16 is applied in advance, are placed on top of each other and supplied to the laminator 22. They are thermally compressed with the hot rollers 20, 21, thereby forming the sheet heating element 10 as a unit.

A polymer resistor formed in such a manner has a PTC characteristic, and the resistance value rises due to the rise in temperature, and when a certain temperature is reached, the resistance value dramatically increases. Since the polymer resistor 14 has a PTC characteristic, the sheet heating element 10 has a self-temperature control function.

Patent Reference 2 discloses a PTC composition formed from an amorphous polymer, crystalline polymer particles, conductive carbon black, graphite, and an inorganic filler. This PTC composition is dispersed in an organic solvent to produce an ink. Then, the ink is printed on a resin film provided with electrodes, to produce a polymer resistor. Additionally, heat treatment is performed to achieve cross-linking. A resin film is deposited on the polymer resistor as a protective layer, thereby completing a sheet heating element. This sheet heating element of Patent Reference 2 has the same PTC heat-emitting characteristic as in Patent Reference 1.

FIG. 3 shows a sectional view of another prior art sheet heating element described in Patent Reference 3. As shown in FIG. 3, a sheet heating element 30 has a flexible substrate 31. Electrodes 32, 33 and a polymer resistor 34 are successively deposited onto this flexible substrate 31 by printing. Then, on top of this is formed a flexible cover layer 35. The substrate 31 has a gas-barrier property and a waterproof property. The substrate 31 comprises a polyester non-woven fabric including long fibers, and a hot-melt film such as of the polyurethane type is bonded to the surface of this polyester non-woven fabric. The substrate 31 can be impregnated with a liquid, such as a polymer resistor ink.

The cover layer 35 comprises a polyester non-woven fabric, and a hot-melt film such as of the polyester type is bonded to the surface of this polyester non-woven fabric. The cover layer 35 also has a gas-barrier property and a waterproof property. The cover layer 35 is adhered to the substrate 31, covering the entirety of the electrodes 32, 33 and the polymer resistor 34. The sheet heating element 30 of Patent Reference 3 is formed in its entirety from six layers. This sheet heating element of Patent Reference 3 also has the same PTC heat-emitting characteristic as in Patent Reference 1.

FIG. 4A and FIG. 4B are drawings showing a mechanism in which a PTC characteristic is exhibited within the polymer resistor 34. The PTC resistor of FIG. 4A and FIG. 4B have particulate conductors 40 such as carbon black. FIG. 4A shows the state under the room temperature condition, and FIG. 6B shows the state when the temperature rises.

As shown in FIG. 4A, within the polymer resistor 34, the particulate conductors 40 make mutual point contact in a resin composition 41, thereby forming conductive passes. When current is applied across the electrodes 32, 33, current flows through the particulate conductors 40 which make point contact, so that the polymer resistor 34 heats up. The resin composition 41 expands, due to the fact that the polymer resistor 34 heats up. Thus, as shown in FIG. 4B, the particulate conductors 40 move away from each other, cutting off contact, so that the resistance value rises, along with the rise in temperature. In other words, the polymer resistor 34 exhibits a positive resistance-temperature characteristic.

FIG. 5 shows the PTC characteristic of the polymer resistor 34. The horizontal axis of FIG. 5 shows the resistivity (resistance per unit length) of the polymer resistor 34. The ratio of the resistivity values of the polymer resistor 34 at 50° C. and at 20° C. was determined experimentally. The vertical axis of FIG. 5 shows the resistivity change ratio (R50/R20). Similar experiments were conducted, varying the type of resin in the polymer resistor 34, the type of conductor 40, and the composition ratio of the resin composition 41 and the conductor 40, to determine the ratios of the resistivity change, and these ratios were plotted in FIG. 5. It is generally the case that resistors with high resistivity change ratios have an excellent PTC characteristic. As shown in FIG. 5, the experiments where the compositions are changed have revealed that the resistivity change ratios of prior art polymer resistors 34 are all 2 or less.

In the prior art sheet heating element 10 of Patent Reference 1 and Patent Reference 2, a rigid material such as a polyester film is used as the substrate 11. In addition, the prior art heating element 10 has a five-layered structure formed from the substrate 11, comb-shaped electrodes 12, 13 printed thereon, the polymer resistor 14, and a cover material 15 having an adhesive layer disposed thereon. As its thickness grows, the sheet heating element 10 loses flexibility. When such a sheet heating element 10 lacking in flexibility is used as a car seat heater, the passenger's seating comfort is compromised. When such a sheet heating element 10 lacking in flexibility is used in a steering wheel heater, the comfortable gripping feel is compromised.

Since the heating element 10 is in the shape of a sheet, if a load is applied to a portion of its surface, for example, when used as a car seat heater and a passenger sits thereon, the force extends to the heating element as a whole, and the heating element 10 changes the shape. Typically, the closer to the edge of the heating element 10, the greater the magnitude of deformation. Thus, wrinkles form unevenly on the heating element. Cracks in the comb-shaped electrodes 12, 13 and in the polymer resistor 14 may result from these wrinkles. Accordingly, such a heating element is thought to have low durability.

The polyester sheets used in the substrate 11 and in the cover material 15 have no ventilation properties. Thus, when the heating element 10 is used in a car seat heater or in a steering wheel heater, liquid given off by a passenger or a driver is readily collects therein. Driving or riding for a long time becomes very uncomfortable.

On the other hand, in the case of the sheet heating element 30 of Patent Reference 3, the electrodes 32, 33, the polymer resistor 34, the substrate, and the cover layer are flexible, so when used in a car seat heater or in a steering wheel heater, it is comfortable to sit or to feel the steering wheel. However, since the sheet heating element 30 is formed from six layers, there are the drawbacks that manufacturing productivity is low and cost is high.

As shown in FIG. 5, the resistivity value of the prior art sheet heating element is 2 or less. At this level of PTC characteristic, the electricity consumption efficiency can by no means be considered good. There is also the drawback that the temperature does not rise quickly. A method for improving the PTC characteristic of the polymer resistor 34 is to increase the mass of the conductor 34. However, when the mass of the conductor 34 is increased, the polymer resistor 34 itself becomes hard and stiff. Thus, it is impossible to stably form a film of the polymer resistor 34 as thin as several 10 micrometers. Furthermore, the film itself has no flexibility, and there is the problem that cracks form during processing, making it difficult to form as film.
Patent Reference 1: Japanese Patent Application Kokai Publication No. S56-13689
Patent Reference 2: Japanese Patent Application Kokai Publication No. H8-120182
Patent Reference 3: U.S. Pat. No. 7,049,559

### SUMMARY OF THE INVENTION

The present invention solves these problems of the prior art, and has as its object to provide a sheet heating element with excellent flexibility, durability, and reliability, as well as low manufacturing cost. When the sheet heating element of the present invention is used in a car seat heater or in a steering wheel heater, the passenger feels comfortable when seated thereon, and the driver feels comfortable when touching the steering wheel.

A PTC resistor according to the present invention comprises at least one PTC composition which comprises at least one resin and at least two conductive materials. The at least two conductive materials comprise at least two conductive materials different from each other. The at least one PTC composition may comprise a first PTC composition which comprises a first resin and at least one first conductive material, and a second PTC composition which is compounded with the first PTC composition and comprises a second resin and at least one second conductive material. The at least one first conductive material is at least partially different from the at least one second conductive material. One of the first and second PTC compositions may form clusters which are distributed within the other of the first and second PTC compositions.

One of the first and second PTC compositions may be contained in the PTC resistor at a content of 20-80 wt. %, preferably 30-70 wt. % or optimally 40-60 wt. %.

One of the first resin and the second resin may comprise a reactant resin and a reactive resin which is cross-linked with the reactant resin. The reactant resin may comprise a modified olefinic resin, which may comprise ester-type ethylene copolymer. Examples of the ester-type ethylene copolymer used in the reactant resin are ethylene/vinyl acetate copolymer, ethylene/ethyl acrylate copolymer, ethylene/methyl methacrylate copolymer, ethylene/methacrylic acid copolymer, and ethylene/butyl acrylate copolymer.

The reactive resin may be contained in said one of the first resin and the second resin at a content of 1-20 wt. %, or preferably 1-10 wt. %.

The reactant resin is reacted with reactive resin and forms a cross-linking structure inside. For this purpose, the reactant and reactive resins may contain different moieties selected from the group consisting of carboxyl groups, carbonyl groups, hydroxyl groups, ester groups, vinyl groups, amino groups, epoxy groups, oxazoline groups, and maleic anhydride groups.

The other of the first resin and the second resin may comprises a moiety selected from the group consisting of carboxyl groups, carbonyl groups, hydroxyl groups, ester groups, vinyl groups, amino groups, epoxy groups, oxazoline groups and maleic anhydride groups. The other of the first resin and the second resin is not reacted with a reactive resin and does not have a cross-linking structure inside.

At least one of the first and second resins may comprise a thermoplastic elastomer. The thermoplastic elastomer may comprise at least one of an olefin-based thermoplastic elastomer, a styrene-based thermoplastic elastomer, a urethane-based thermoplastic elastomer, and a polyester-based thermoplastic elastomer. The thermoplastic elastomer may be contained at a content of 5-20 wt. % in the at least one of the first and second resins.

The at least one first conductive material may contain at least one kind of conductive material which is not contained in the at least one second conductive material. Under this condition, the at least one first conductive material and the at least one second conductive material may each comprise at least one of carbon black, graphite, carbon nanotubes, carbon fibers, conductive ceramic fibers, conductive whiskers, metal fibers, conductive inorganic oxides, and conductive polymer fibers. Also, at least one of the first and second conductive materials is made in the form of flakes.

One of the at least one first conductive material and the at least one second conductive material may be contained in the first or second PTC composition at a content of 30-90 wt. %, preferably 40-80 wt. % or optimally 60-70 wt. %. The other one of the at least one first conductive material and the at least one second conductive material may be contained in the first or second PTC composition at a content of 20-80 wt. %, preferably 30-70 wt. %, or optimally 30-60 wt. %.

The PTC resistor according to the present invention may have an electric resistivity ranging between 0.0007 Ω·m and 0.016 Ω·m or preferably between 0.0011 Ω·m and 0.0078 Ω·m.

Also, the PTC resistor according to the present invention may exhibit an electric resistivity at 50° C. which is at least twice as high as the electric resistivity thereof measured at 20° C. At a temperature lower than 50° C., the PTC resistor according to the present invention may exhibit an electric resistivity lower than an electric resistivity of either the first or second PTC composition, while at a temperature above 50° C., exhibiting an electric resistivity higher than those of the first and second PTC composition.

The PTC resistor according to the present invention may extend by more than 5% with a load of less than 7 kgf.

The PTC resistor according to the present invention may have a thermal expansion coefficient of between 20×10⁻⁵/K and 40×10⁻⁵/K.

At least one of the first and second PTC compositions may comprise a flame retardant agent. The flame retardant agent may comprise at least one of a phosphorus-based flame retardant, a nitrogen-based flame retardant, a silicone-based flame retardant, an inorganic flame retardant and a halogen-based flame retardant. Due to inclusion of the flame retardant agent, the PTC resistor according to the present invention satisfies at least one of the following conditions:

(a) When an end of the PTC resistor is burned with a gas flame, and the gas flame is extinguished after 60 seconds, the PTC resistor does not burn, even if the PTC resistor is charred;

(b) When an end of the PTC resistor is burned with a gas flame, the PTC resistor catches fire for no more than 60 seconds, but the flame extinguishes within 2 inches; or

(c) When an end of the PTC resistor is burned with a gas flame, even if the PTC resistor catches fire, the flame does not advance at a rate of 4 inches/minute or more in an area ½ inch thick from the surface.

The flame retardant agent may be contained in the PTC resistor at a content of 5 wt. % or more, preferably 0-30 wt. %, or optimally 15-25 wt. %.

The PTC resistor according to the present invention may comprise a liquid-resistant resin. The liquid-resistant resin comprises at least one of an ethylene/vinyl alcohol copolymer, a thermoplastic polyester resin, a polyamide resin, a polypropylene resin and an ionomer. The liquid-resistant resin is contained at a content of 10 wt. % or more with respect to the first and second PTC compositions, preferably 10-70 wt. % or optimally 30-50 wt. %. As explained above, one of the first resin and the second resin may comprise a reactant resin and a reactive resin which is cross-linked with the reactant resin.

The reactive resin may comprise a liquid-resistant resin. Since the sheet heating element of the present invention is formed from a flexible and stable polymer resistor having a high PTC characteristic, it is able to exhibit excellent performance as a heating element, as well as excellent long-term durability and reliability, and due to a high level of flexibility and processability, the manufacturing productivity can be increased and it is possible to produce a low-cost polymer resistor.

### BRIEF DESCRIPTION OF THE ATTACHED DRAWINGS

FIG. 1A is a transparent plan view of a prior art sheet heating element.

FIG. 1B is a sectional view of the sheet heating element shown in FIG. 1A.

FIG. 2 is an abbreviated sectional view of an example of the structure of a manufacturing device of a prior art sheet heating element.

FIG. 3 is a sectional view of another prior art sheet heating element.

FIG. 4A is a drawing showing a mechanism for exhibiting a PTC characteristic when a prior art particulate conductor is used.

FIG. 4B is a drawing sowing the state where the temperature rises from the state shown in FIG. 4A.

FIG. 5 is a graph showing the relationship between the resistivity value of the polymer resistor 5 and the ratio of the resistivity values of the polymer resistor at 50° C. and 20° C. (R50/R20).

FIG. 6A is a graph showing the composition of the polymer resistor 60 of the sheet heating element 1 according to the present invention and a mechanism for exhibiting a PTC characteristic.

FIG. 6B is a drawing showing the state where the temperature rises from the state shown in FIG. 6A.

FIG. 7 is a graph showing the relationship between the resistivity of the polymer resistor 60 and the ratio of the resistivity values of the polymer resistor at 50° C. and 20° C. (R50/R20).

FIG. 8 is a graph showing the relationship between the average thermal expansion coefficient per 1° C. in the temperature range of −20° C. and 80° C. and the resistivity change factor.

FIG. 9 is a graph showing the relationship between the time for the polymer resistor to reach a specified temperature after electrical power is applied thereto, and the resistivity change factor.

FIG. 10A is a plan view of a sheet heat element of Embodiment 1 of the present invention.

FIG. 10B is a sectional view of the sheet heating element of FIG. 10A.

FIG. 11A is a transparent lateral view of a car seat to which is attached a sheet heating element of Embodiment 1 of the present invention.

FIG. 11B is a transparent frontal view of the seat shown in FIG. 1A.

FIG. 12A is a plan view of a sheet heating element of Embodiment 2 of the present invention.

FIG. 12B is a sectional view of the sheet heating element shown in FIG. 12A.

FIG. 13A is a plan view of a sheet heating element of Embodiment 3 of the present invention.

FIG. 13B is a sectional view of the sheet heating element shown in FIG. 13A.

FIG. 14A is a plan view of a sheet heating element of Embodiment 4 of the present invention.

FIG. 14B is a sectional view of the sheet heating element shown in FIG. 14A.

FIG. 15A is a plan view of a sheet heating element of Embodiment 5 of the present invention.

FIG. 15B is a sectional view of the sheet heating element shown in FIG. 15A.

FIG. 16A is a plan view of a sheet heating element of Embodiment 6 of the present invention.

FIG. 16B is a sectional view of the sheet heating element shown in FIG. 16A.

FIG. 17A is a plan view of a sheet heating element of Embodiment 7 of the present invention.

FIG. 17B is a sectional view of the sheet heating element shown in FIG. 17A.

FIG. 18A is a plan view of a sheet heating element of Embodiment 8 of the present invention.

FIG. 18B is a sectional view of the sheet heating element shown in FIG. 18A.

FIG. 19A is a plan view of a sheet heating element of Embodiment 9 of the present invention.

FIG. 19B is a sectional view of the sheet heating element shown in FIG. 19A.

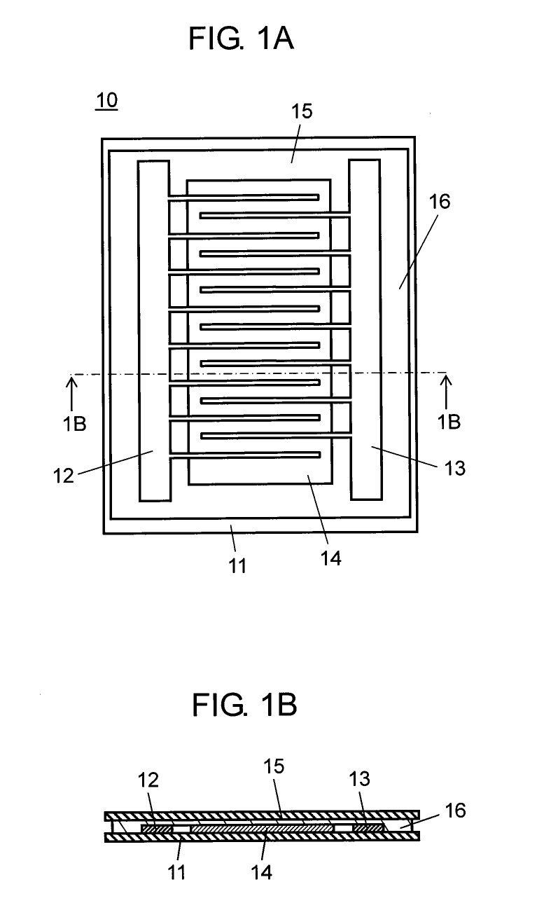

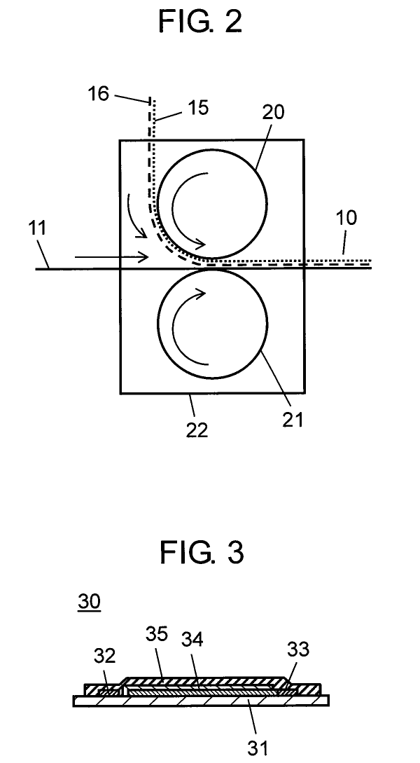

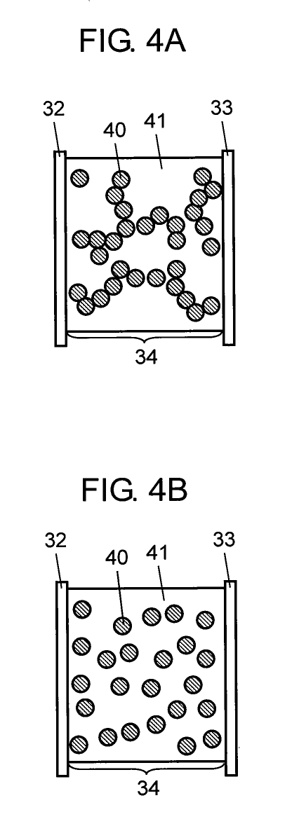

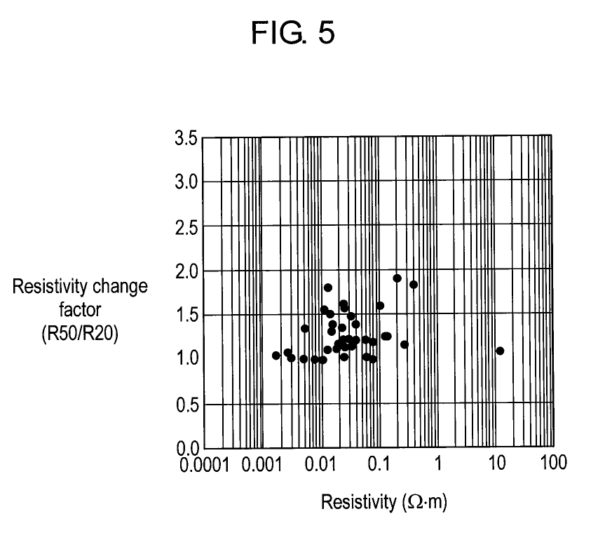

### DETAILED DESCRIPTION OF THE PREFERRED EMBODIMENT

Embodiments of the present invention are described below with reference to the drawings. It should be noted that the present invention is not limited to these embodiments. Moreover, structures particular to the various embodiments can be suitably combined.

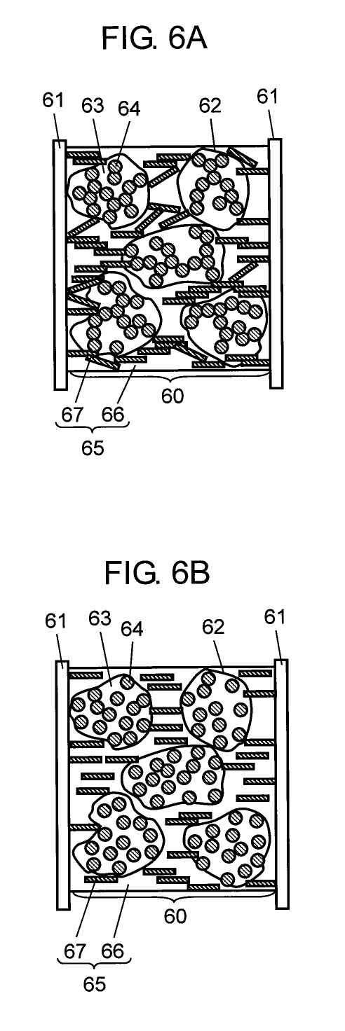

FIG. 6A and FIG. 6B are drawings showing the polymer resistor 60 used in the sheet heating element of the present invention. FIG. 6A shows the internal structure of the polymer resistor 60 at room temperatures, and FIG. 6B shows the internal structure of the polymer resistor 60 when the temperature has risen. As described below, the polymer resistor 60 of the present invention can be used as a heat source of a car seat heater. In this case, the polymer resistor 60 is formed in a film configuration, and emits heat when electricity is supplied via a pair of line electrodes 61.

The polymer resistor 60 has a resistor composition 62, and the resistor composition 62 is formed from a resin composition 63 and a conductor 64. Furthermore, the polymer resistor 60 has a resistor composition 65, and the resistor composition 65 is formed from a resin composition 66 and a conductor 67. As shown in FIG. 6A, the structure is such that a plurality of clusters of the resistor composition 62 are distributed within the polymer resistor 60, and the resistor composition 65 surrounds the clusters.

The above-described characteristic can be achieved if the polymer resistor 60 contains the resistor composition 62 at a content of 20-80 wt, % (the remainder is the resistor composition 65). preferably 30-70 wt. % (the remainder is the resistor composition 65), and in particular, optimally 40-60 wt. % (the remainder is the resistor composition 65). As the content of the resistor composition 62 approaches the optimal range, the processability and the PTC characteristic of the polymer resistor 60 increase.

The resin composition 63 is primarily formed from a reactant resin, so as to achieve a PTC characteristic. A heat-emitting temperature of 40-50° C. required for a car seat heater is a relatively low temperature. Therefore, a low-melting point modified olefinic resin such as ethylene/vinyl acetate copolymer, ethylene/ethyl acrylate copolymer, ethylene/methyl methacrylate copolymer, ethylene/methacrylic acid copolymer, ethylene/butyl acrylate copolymer, or other ester-type ethylene copolymer can be used as the reactant resin.

Moreover, when the reactant resin reacts with a reactive resin, there formed an internal cross-linked structure. Modified polyethylene having carboxyl groups is effective as a reactant resin exhibiting a PTC characteristic, and modified polyethylene having epoxy groups can be used as a reactive resin which reacts therewith. When these are blended by kneading, the carbonyl groups in the reactant resin react with the oxygen of the epoxy groups in the reactive resin, chemically bonding, and forming a cross-linked structure.

The above-described characteristic can be achieved if the resin composition 63 contains the reactive resin at a content of 1-20 wt. % (the remainder is the reactant resin), preferably 1-10 wt. % (the remainder is the reactant resin), and in particular, optimally 2-5 wt. % (the remainder is the reactant resin). As the content of the reactive resin approaches the optimal range, the processability and the PTC characteristic of the polymer resistor 60 increase.

This cross-linking reaction can occur via nitrogen in addition to oxygen. A cross-linking reaction occurs if a reactive resin containing a functional group containing at least either oxygen or nitrogen and a reactant resin possessing a functional group capable of reacting with the functional group of the reactive resin are blended by kneading. Examples of functional groups of the reactive resin and functional groups of the reactant resin other than the above-described epoxy groups and carbonyl groups, are given below.

Examples of functional groups of the reactant resin, other than carbonyl groups, include epoxy groups, carboxyl groups, ester groups, hydroxyl groups, amino groups, vinyl groups, maleic anhydride groups, and oxazonline groups in addition polymerization. Examples of functional groups of the reactive resin, other than epoxy groups, include oxazoline groups and maleic anhydride groups.

Since the reactant resin has a cross-linked structure due to reacting with the reactive resin in the resin composition 63 of the resistor composition 62, the temperature characteristics of the thermal expansion ratio and melting temperature characteristics of the resistor composition 62 are more stable because of this cross-linking reaction, than in the case where the resin composition 63 is formed by a reactant resin alone.

Since the reactive resin and the reactant resin bond firmly due to the cross-linked structure, even under repeated cooling and heating, resulting in repeated thermal expansion and thermal contraction, the temperature characteristics of the thermal expansion ratio and the melting temperature characteristics of the resistor composition 62 are maintained, so that variation thereof with the passage of time is suppressed. In other words, even as time passes, the resistor composition 62 maintains constant temperature characteristics of the thermal expansion ratio and constant melt-temperature characteristics.

It is not necessarily required to prepare the resin composition 63 by blending the reactant resin and the reactive resin by kneading. A PTC characteristic can be exhibited even if the reactant resin is used by itself. Therefore, if change over time in the PTC characteristic is allowed to some degree, the reactant resin can be used by itself. When the reactant resin is used by itself, the type of reactant resin will be suitably selected according to the desired PTC characteristic value.

In the above description, the reactive resin and the reactant resin are reacted so as to impart a cross-linked structure to the reactant resin of the resin composition 63. However, a cross-linking agent can be used that differs from the reactive resin. Moreover, it is also possible to form a cross-linked structure in the reactant resin without using a reactive resin, but instead, by irradiating the reactant resin with an electron beam. In this case, it is possible to use a reactant resin which does not have the above-mentioned functional groups.

The resin composition 66 of the resistor composition 65 is preferably a resin containing at least one moiety selected from carboxyl groups, carbonyl groups, hydroxyl groups, ester groups, vinyl groups, amino groups, epoxy groups, oxazoline groups, and maleic anhydride groups. These functional groups are the same functional groups possessed by the reactant resin and the reactive resin of the resin composition 63. Accordingly, the resin composition 66 has a similar chemical nature as the resin composition 63, and the affinity of the two of them increases. By using the resin composition 66 which has a high affinity to the resin composition 63, the adhesive force (bonding force) of the resistor resin 62 and the resistor resin 65 increases. At the same time, it is possible to uniformly disperse the resin composition 66 within the polymer resistor.

The resin composition 63 becomes harder due to the cross-linking reaction. Since the resin composition 66 does not have a cross-linked structure, it is flexible, and does not harden like the resin composition 63. Due to the fact that this flexible resin composition 66 envelopes the hard resin composition 63, the polymer resistor 60 becomes flexible. Accordingly, the polymer resistor 60 can be formed into a film by using a simple mechanical process known as extrusion molding, making it possible to increase the productivity in manufacturing the sheet heating element and to lower the cost.

As described below in an embodiment of the present invention, electricity is supplied to a sheet heating element by using the pair of line electrodes 61 separated by a space. In order to supply sufficient exothermic current by means of such separated electrodes, it is necessary to reduce the resistivity value of the polymer resistor 60. A makeshift method for reducing the resistivity is to increase the amount of the conductor 64 in the resin composition 63. However, when the amount of the conductor 64 is increased, the resin composition 63 would harden. In the present invention, the flexibility of the polymer resistor 60 can be maintained, while reducing the resistivity value thereof, by adding the flexible resin composition 66 to the polymer resistor 60.

Moreover, the resin composition can be made more flexible by adding a thermoplastic elastomer to at least the resin composition 63 and/or the resin composition 66. At least one species selected from an olefin-based thermoplastic elastomer, a styrene-based thermoplastic elastomer, a urethane-based thermoplastic elastomer, and a polyester-based thermoplastic elastomer, can be used as the thermoplastic elastomer.

The amount of thermoplastic elastomer added to the resin composition 63 and the resin composition 66 is preferably in a range of 5-20 wt. % (the remainder is the resin composition 63 or the resin composition 66). When the thermoplastic elastomer content is within this range, the flexibility of the polymer resistor 60 particularly increases.

Following is an explanation of the conductor 64 in the resistor composition 62 and the conductor 67 in the resistor composition 65. In the present invention, the conductor 64 and the conductor 67 are different types of conductors. Although a single type of conductor can be used respectively as the conductor 64 and the conductor 67, mixtures of two or more types of conductors can be used respectively. In this case, it is preferable that at least one type of conductor forming the conductor 64 is not contained in the conductor 67.

The conductor 64 is preferably carbon black, and the conductor 67 is preferably flake graphite. In addition to these, at least one species selected from carbon black, graphite, carbon nanotubes, carbon fibers, conductive ceramic fibers, conductive whiskers, metal fibers, conductive inorganic oxides, and conductive polymer fibers, can be used as the conductor 64 and the conductor 67, respectively.

Tin-plated and antimony-doped titanium oxide is an example of a conductive ceramic fiber. A metal-plated potassium titanate-based compound is an example of a conductive whisker. Aluminum is an example of a metal fiber. Polyaniline is an example of a conductive polymer fiber. Metal-plated mica is an example of a conductive inorganic oxide.

The conductors used in the conductor 64 and the conductor 67 are suitably selected according to the desired PTC characteristic. The resistivity of the polymer resistor 60 is suitably selected according to the mode of usage of the polymer resistor 60. For example, if it is to be thin and elongated for use in a car seat heater, the resistivity of the polymer resistor depends on the space between the line electrodes, and preferably ranges from about 0.0007 Ω/m to about 0.016 Ω/m, and optimally ranges from about 0.0011 Ω/m to about 0.0078 Ω/m.

Furthermore, at least one type of metallic powder and conductive non-metallic powder can also be added to the resistor composition 65, thereby making it possible to lower the resistivity of the polymer resistor 60.

As shown in FIG. 6A, when the sheet heating element is not in a state where it is emitting heat, the conductors 64 in the resistor composition 62 are close to one another and contacting one another at points in the resin composition 63, thereby forming conductive passes. On the other hand, the conductors 67 in the resistor composition 65 are also close to one another, thereby forming conductive passes.

When current is applied across the electrodes 61, current flows through the conductive passes of the conductor 64 and the conductive passes of the conductor 67, and the polymer resistor 60 heats up. When the polymer resistor 60 heats up, the resin composition 63 and the resin composition 66 undergo thermal expansion. As shown in FIG. 6B, along with the thermal expansion of the resins, the conductors 64 move away from each other, and the conductors 66 also move away from each other. As a result, the conductive passes are cut, and the resistance of the polymer resistor 60 rises. In other words, as the temperature rises, a PTC characteristic is exhibited in which the resistance of the polymer resistor 60 rises.

Due to the fact that the graphite or conductive inorganic oxide is in the form of flakes, the contact surface areas among the conductors increase. In other words, the electrical resistance of the polymer resistor 60 decreases at low temperatures. As a result, as the temperature rises, the resistance of the polymer resistor 60 dramatically increases. In other words, the polymer resistor 60 exhibits an excellent PTC characteristic which has highly positive resistance-temperature characteristics.

As described above, the reactant resin, which is a main composition of the resin composition 63 of the resistor composition 62 is caused to form a cross-linked structure by reacting this reactant resin with the reactive resin. Due to this cross-linked structure, the conductor 64 in the resin composition 63 is positioned stably, and conductive passes are stably formed at low temperatures. On the other hand, when the temperature rises, it will be always constant at which the conductive passes are cut. In other words, the cross-linked structure makes it possible for the polymer resistor 60 to constantly exhibit a stabile PTC characteristic.

The above-described characteristic can be achieved if the resistor composition 62 contains the conductor 64 at a content of 30-90 wt. % of (the remainder is the resin composition 63), preferably 40-80 wt. % (the remainder is the resin composition 63), and in particular, optimally 60-70 wt. % (the remainder is the resin composition 63). On the other hand, the above-described characteristic can be achieved if the resistor composition 65 contains the conductor 67 at a content of 20-80 wt. % (the remainder is the resin composition 66), preferably 30-70 wt. % (the remainder is the resin composition 66), and in particular, optimally 30-60 wt. % (the remainder is the resin composition 66). As the content of the conductor 64 and the conductor 67 approaches the optimal range, the processability and the PTC characteristic of the polymer resistor 60 increase.

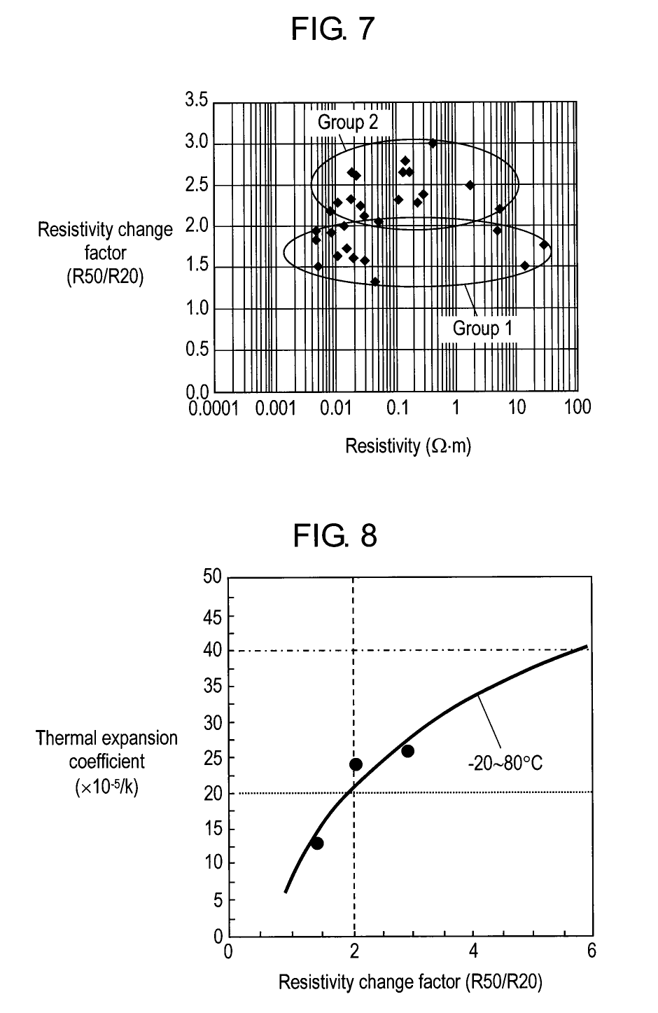

FIG. 7 is a graph showing the relationship between the resistivity of the polymer resistor 60 at 20° C. and the resistance change factor, which is the ratio of resistivity values of the polymer resistor at 50° C. and 20° C. (R50/R20). The higher the resistivity change factor (R50/R20), the greater the change in the resistance at low and high temperatures. In other words, the higher the resistivity change factor (R50/R20), the better the PTC characteristic.

Tests were conducted in which the types of resin composition 63, the conductor 64, the resin composition 66, and the conductor 67 were variously changed, and the resistivity values for each were measured at 50° C. and at 20° C., to obtain the resistivity change factors (R50/R20). Moreover, the composition ratios of these components were varied and similar tests were conducted. FIG. 7 shows plots of the resistivity change factor (R50/R20) in each of these cases.

The test results are shown in FIG. 7, where the polymer resistors 60 used in the tests are divided into two groups. In the case of the polymer resistor 60 shown as Group 1, tests were conducted after varying the type of components and their composition ratios, but the same material was always used as the conductor 64 and the conductor 67. In the case of the polymer resistor 60 shown as Group 2, tests were likewise conducted after varying the type of components and their composition ratios, but different materials were always used as the conductor 64 and the conductor 67.

As shown in FIG. 7, in the case of Group 1 (the same material was used as the conductor 64 and the conductor 67), the resistivity at 20° C. ranged from 0.05 Ω/m to 12 Ω/m, and the over-all resistivity change factor (R50/R20) was 2 or lower. In the case of Group 2 (different materials were used as the conductor 64 and the conductor 67), the resistivity at 20° C. ranged from 0.08 Ω/m to 4 Ω/m, and the over-all resistivity change factor (R50/R20) was 2 or higher

Changes in the resistivity accompanying rises in temperature were measured for the polymer resistor 60 with a resistivity change factor (R50/R20) of 2 or higher. Moreover, changes in the resistivity value accompanying rises in temperature were likewise measured for each of the resistor composition 62 and the resistor composition 65, which form the polymer resistor 60. When the results of these measurements were compared, the resistivity of the polymer resistor 60 at a temperature lower than 50° C. was found to be lower than the resistivity of the resistor composition 62 and the resistivity of the resistor composition 65 at the same temperature.

As the temperature rises to approach 50° C., the resistivity of the polymer resistor 60 approaches the resistivity of the resistor composition 62 and the resistivity of the resistor composition 65. When the temperature exceeds 50° C., the resistivity of the polymer resistor 60 becomes greater than the resistivity values of the resistor composition 62 and the resistor composition 65.

In other words, it was found that when the resistor composition 62 and the resistor composition 65 are mixed, a higher temperature characteristic is exhibited than the temperature characteristic exhibited by each of them individually. It was also found that when the resistor composition 62 and the resistor composition 65 are mixed, the resistivity at low temperatures is lower than the resistivity values of each of them individually, and the resistivity at high temperatures is higher than the resistivity values of each of them individually. This characteristic is considerable, particularly when carbon black is used as the conductor 64 and when graphite is used as the conductor 67.

The reason why this phenomenon occurs is not understood, but it is thought that, due to the fact that the types of conductor differ, the shape and size of the particles, the density of the conductive passes in the resistor compositions 62 and 65, and the electrical conduction between the resin compositions 63 and 66 influence each other. In addition, the difference in thermal expansion and the difference in melting temperature between the resin compositions 63 and 66 play an influential role.

Next, 3 types of resin compositions with different melting points were used to produce the polymer resistor 60 in 3 types of films. The type and amount of conductor in these 3 types of resin compositions were identical. However, the resistivity change factors (R50/R20) for these 3 types of resin compositions are about 1.4, about 2.0, and about 2.9, respectively. The melting points of these resin compositions were about 40° C. for the polymer resistor film with a resistivity change factor of about 1.4; about 60° C. for the polymer resistor film with a resistivity change factor of about 2.0; and about 80° C. for the polymer resistor film with a resistivity change factor of about 2.9. The thermal expansion of these 3 types of polymer resistor films in the planar orientation was tested using a thermal analysis instrument TMA-50 (Shimadzu Corporation). The results are given in FIG. 8.

In detail, while varying the temperature 1° C. at a time in a temperature range of −20° C. to 80° C., the thermal expansion coefficient was measured for each of the 3 types of polymer resistors at each increment, and finally, the thermal expansion coefficients were averaged. FIG. 8 shows the relationship between the average thermal expansion coefficient and the resistivity change factor for the three resistors. FIG. 8 clearly shows that the smaller the resistivity change factor, the smaller the thermal expansion coefficient, and the larger the resistivity change factor, the larger the thermal expansion coefficient. In other words, polymer resistors using resin compositions with lower melting points exhibit higher resistivity change factors. These tests show that polymer resistors using low-melting point resin compositions have high thermal expansion coefficients in low temperature ranges.

FIG. 8 joins the 3 resulting average thermal expansion coefficients in a curve. This curve shows that the average thermal expansion coefficient for polymer resistors for which the resistivity change factor is 2 is approximately 20×10⁻⁵/K. Based on this finding, it can be conjectured that the average thermal expansion coefficient for polymer resistors for which the resistance change factor is 2 or more is approximately 20×10⁻⁵/K or more. In other words, polymer resistors with an average thermal expansion coefficient of 20×10⁻⁵/K or more are thought to exhibit a favorable PTC characteristic.

The thermal expansion coefficient of a resin composition typically reaches a maximum in the vicinity of its melting point, and gradually declines when this point is exceeded. If a resin composition is melted beyond the melting point, the concept of a thermal expansion coefficient for a solid no longer applies. Therefore, if the maximum thermal expansion coefficient in the vicinity of the melting point is used as an upper limit, the range of thermal expansion coefficients of polymer resistors exhibiting a favorable PTC characteristic is 20×10⁻⁵/K to 40×10⁻⁵/K.

If the thermal expansion coefficient of the polymer resistor is greater than the thermal expansion coefficient of the substrate to which the polymer resistor is attached, there is a possibility that wrinkles could form in the polymer resistor when it heats up, and durability could be lost. Therefore, when selecting a polymer resistor with a thermal expansion coefficient in the above range, it is necessary to consider the thermal expansion coefficient of the substrate to which the polymer resistor is attached.

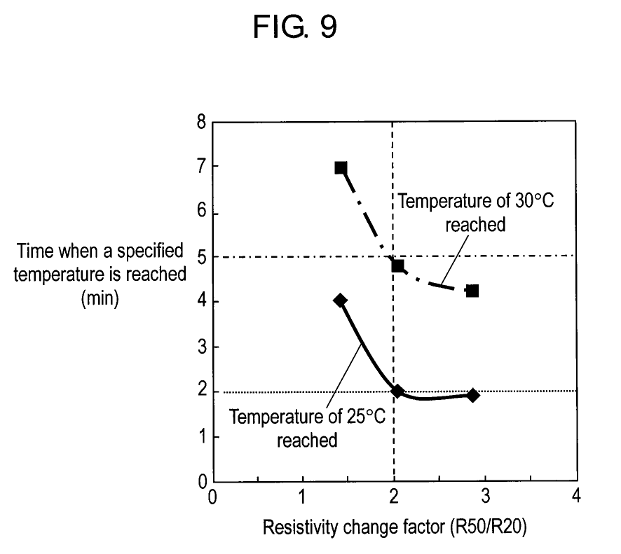

FIG. 9 shows the relationship between time and resistivity change factor when electrical power was applied to the 3 types of polymer resistors, and the time was measured until the polymer resistor reached temperatures of 25° C. and 30° C. The temperature when electrical power started to be applied was −20° C., and the hypothetical use was in a car seat heater, and the polymer resistor was compressed to simulate a state in which a passenger is seated. At the time when electrical power started to be applied, it was set so as to be constant when the temperature reached about 40° C. In other words, the lower the resistivity change factor, the lower the electrical power at initial application.

FIG. 9 indicates that polymer resistors with greater resistivity change factors show a faster rise in temperature. FIG. 9 joins the resulting 3 points in a curve for the temperatures 25° C. and 30° C., respectively. The curve shows that polymer resistors with a resistivity change factor of 2 take about 2 minutes to reach 25° C., and about 5 minutes to reach 30° C. When the sheet heating element 60 is used in a car seat heater, it is said to be preferable empirically that the sheet heating element generates heat such that the time to reach 20° C. is within 2 minutes, and the time to reach 30° C. is within 5 minutes. As shown in FIG. 9, it was confirmed that the resistivity change factor of a polymer resistor must be 2 or more is needed to satisfy the empirical provision.

If the polymer resistor 60 is used in a car seat heater, it is even more advantageous for the polymer resistor 60 to contain a flame retardant agent. A car seat heater must satisfy the flammability standard of U.S. FMVSS 302. Specifically, it must satisfy any one of the conditions given below.
(1) When an end of the polymer resistor 60 is burned with a gas flame, and the gas flame is extinguished after 60 seconds, the polymer resistor 60 itself does not burn, even if the polymer resistor 60 is charred.
(2) When an end of the polymer resistor 60 is burned with a gas flame, the polymer resistor 60 catches fire for no more than 60 seconds but the flame extinguishes within 2 inches.
(3) When an end of the polymer resistor 60 is burned with a gas flame, even if the polymer resistor 60 catches fire, the flame does not advance at a rate of 4 inches/minute or more in an area ½ inch thick from the surface.

Incombustibility is defined as follows. An end of a specimen is burned for 60 seconds with a gas flame. When the flame is extinguished after 60 seconds, the specimen does not burn even though charred remnants remain on the specimen. Self-extinguishing refers to a specimen catching fire for no more 60 seconds, and the burned portion is within 2 inches.

Specifically, the standards for flammability can be satisfied by adding a flame retardant agent to the resistor composition 62 and/or the resistor composition 65 which form polymer resistor 60. The flame retardant agent can be a phosphorus-based flame retardant such as ammonium phosphate or tricresyl phosphate; a nitrogen-based compound such as melamine, guanidine, or guanylurea; or a silicone-based compound; or a combination of these. An inorganic flame retardant such as magnesium oxide or antimony trioxide, or a halogen-based flame retardant such as a bromine-based or chlorine-based compound can be used.

It is particularly advantageous if the flame retardant agent is a liquid at room temperatures, or has a melting point such that it melts at the mixing temperature. The flexibility of the resistor composition 62 and the resistor composition 65 can be increased by using at least one type of phosphorus-based, ammonium-based, or silicone-based compound, thereby making it possible to increase the flexibility of the polymer resistor 60 as a whole.

The amount of flame retardant agent added is determined as follows. If there is little flame retardant agent, the incombustibility becomes poor, and any of the above conditions for incombustibility are not satisfied. In view of this, the amount of flame retardant agent to be added should be 5 wt. % or more with respect to the polymer resistor 60. However, when the amount of flame retardant agent increases, the compositional balance between the resin compositions 63, 66 and the conductors 64, 67 contained therein becomes poor, the resistivity of the polymer resistor 60 increases, and the PTC characteristic becomes poor. In view of this, the amount of added flame retardant agent is preferably 10-30 wt. %, and optimally 15-25 wt. %, with respect to the polymer resistor 60.

The flame retardant agent can be added after mixing the resistor composition 62 and the resistor composition 65. It can be added in advance to at least the resin composition 63 forming the resistor composition 62 and/or the resin composition 66 forming the resistor composition 65. Flame retardant properties can be achieved by the presence of a flame retardant agent in the polymer resistor 60.

It is advantageous to add a liquid-resistant resin to the polymer resistor 60, so as to impart liquid resistance to the polymer resistor 60. Liquid resistance prevents the polymer resistor 60 from deterioration due to contact with liquid chemicals such as inorganic oils including engine oil, polar oils such as brake oil, and other oils, or low-molecular weight solvents such as thinners and other organic solvents.

When the polymer resistor 60 comes into contact with the above liquid chemicals, the resin composition 63 and the resin composition 66, which contain large quantities of amorphous resin, readily expand and the volume changes, so that the conductive passes of the conductors are broken and the resistance rises. This phenomenon is identical to changes in volume (or PTC characteristic) due to heat. When the polymer resistor 60 comes into contact with a liquid chemical described above, the initial resistivity value is not recovered, even if the liquid dries. Even if it is recovered, the recovery takes time.

In order to impart liquid resistance to the polymer resistor 60, a highly crystallized liquid-resistant resin is added to the polymer resistor 60 so that the resin composition 63, the resin composition 66, the conductor 64, and the conductor 67 are partially chemically bonded to the liquid-resistant resin. As a result, even if the polymer resistor 60 comes into contact with a liquid chemical described above, expansion of the resin composition 63 and the resin composition 66 is inhibited.

The liquid-resistant resin contains one species selected from an ethylene/vinyl alcohol copolymer, a thermoplastic polyester resin, a polyamide resin, a polypropylene resin, or an ionomer, or can contain a combination thereof. These liquid-resistant resins not only impart liquid resistance to the polymer resistor 60, but they also function to prevent a decrease in flexibility of the resin composition 63 and the resin composition 66. In other words, these liquid-resistant resins support the flexibility of the polymer resistor 60.

The amount of liquid-resistant resin added is preferably 10 wt. % or more with respect to the resin composition 63 and the resin composition 66 in the polymer resistor 60. Thereby, the liquid resistance of the polymer resistor 60 increases. However, when there is a large amount of liquid-resistant resin, the polymer resistor 60 itself will harden, and its flexibility will decrease. Also, the conductors will be captured within the liquid-resistant resin, and the conductive passes will hardly be cut off even when the temperature rises, and the PTC characteristic will eventually drop. Therefore, in order to support the flexibility of the polymer resistor, and to maintain a favorable PTC characteristic, the amount of liquid-resistant resin is preferably in the range of 10-70 wt. %, and optimally 30-50 wt. %.

The following test was conducted to investigate the effects of the liquid-resistant resins described above. First, a plurality of polymer resistors 60 were prepared without containing a liquid-resistant resin, and a plurality of polymer resistors 60 were prepared containing respectively differing liquid-resistant resins (50 wt. %). The above-mentioned liquid chemical was dripped onto these polymer resistors 60, and they were allowed to stand for 24 hours. After applying an electric current to these polymer resisters 60 for 24 hours, they were allowed to stand at room temperature for 24 hours. The resistivity values of these polymer resistors were measured before and after the test. It was found that polymer resistors 60 which did not contain a liquid-resistant resin showed a 200-300-fold increase in resistivity as compared to before the test.

By contrast, in all of the polymer resistors 60 which contained liquid-resistant resins, the increase in resistivity was no more than 1.5-3-fold as compared to before the test. This test showed that adding a liquid-resistant resin to the polymer resistor 60 makes it possible to inhibit the expansion of the resin composition 63 and the resin composition 66 forming the polymer resistor 60 which may be caused by contact with a liquid chemical such as organic solvents or beverages. In other words, the resistivity of the polymer resistor 60 can be stabilized, and the sheet heating element can have a high level of durability, by adding a liquid-resistant resin to the polymer resistor 60.

The above-described liquid-resistant resin can be added after mixing the resistor composition 62 and the resistor composition 65. However, the liquid-resistant resin is added with the aim of increasing the liquid resistance of the resin composition 63 forming the resistor composition 62, or the resin composition 66 forming the resistor composition 65, so it is advantageous to add at least the resin composition 63 and/or the resin composition 66 in advance. However, whichever method is used, the polymer resistor 60 is able to exhibit liquid resistance since ultimately, a liquid-resistant resin is present in the polymer resistor 60.

In the above polymer resistor 60 according to the present invention, two kinds of resistor compositions 62 and 65 are present, which contain resin compositions 63 and 66, respectively. The purpose of the present invention can also be achieved by forming the polymer resistor with a single resin resistor composition containing a single resin composition.

The single resin composition comprises a low-melting point modified olefinic resin such as ethylene/vinyl acetate copolymer, ethylene/ethyl acrylate copolymer, ethylene/methyl methacrylate copolymer, ethylene/methacrylic acid copolymer, ethylene/butyl acrylate copolymer, and other ester-type ethylene copolymer. The resin composition may also comprises a reactive resin such as described above to impart an cross-linking structure to the resin resistor composition. The above described functional groups provide the resin composition and the reactive resin with the ability to cross-link with each other. Absent the reactive resin, the cross-linking structure can be imparted to the resin resistor composition by irradiating the resin composition with an electron beam.

The single resin composition can be made flexible by adding thereto at least one of the above described thermoplastic elastomers at the above described content.

The single resin resistor composition contains at least two kinds of conductors selected from the above-described conductors at the above described contents. The conductors used in the resin resistor composition are suitably selected according to the desired PTC characteristic. The resistivity of the polymer resistor is suitably selected according to the mode of usage of the polymer resistor. For example, if it is to be thin and elongated for use in a car seat heater, the resistivity of the polymer resistor depends on the space between the line electrodes, and preferably ranges from about 0.0007 Ω/m to about 0.016 Ω/m, and optimally ranges from about 0.0011 Ω/m to about 0.0078 Ω/m.

### Embodiment 1 of a Sheet Heating Element

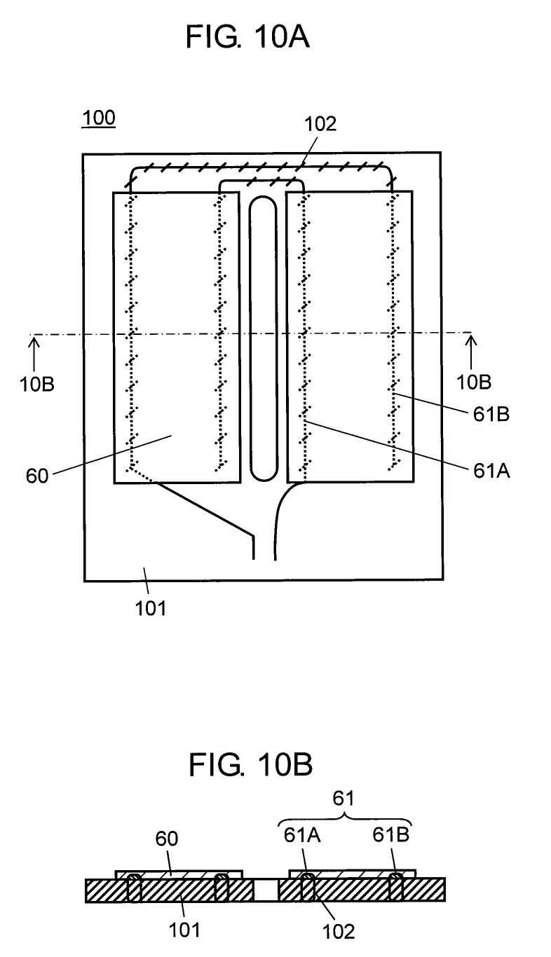

Following is a description of an embodiment of a sheet heating element using the above-described polymer resistor. FIG. 10A is a plan view of Embodiment 1 of the sheet heat element of the present invention, and FIG. 10B is a sectional view of the sheet heating element of FIG. 10A along the line 10B-10B.

A sheet heating element 100 includes an insulating substrate 101, a first line electrode 61A, a second line electrode 61B, and the polymer resistor 60. The line electrodes 61A, 61B are sometimes referred together as line electrodes 61. The line electrodes 61A, 61B are disposed right-left symmetrically on the insulating substrate 101, and are partially sewn onto the insulating substrate 101 with a thread 102. Using a T-die extruder, for example, the polymer resistor 60 can be extruded as a film onto the insulating substrate 101 onto which the line electrodes 61 have been attached, and melt-adhered together with a laminator, so as to make electrical contact with the line electrodes 61.

After the polymer resistor 60 is melt-adhered to the line electrodes 61 and the insulating substrate 101, the central portion of the sheet heating element is punched. The position where the central portion is punched is not limited to the position shown in the drawing. There are cases in which the punching of the central portion is in other positions, depending on the application. In order to avoid punching, the wiring pattern of the line electrodes 61 must be modified.

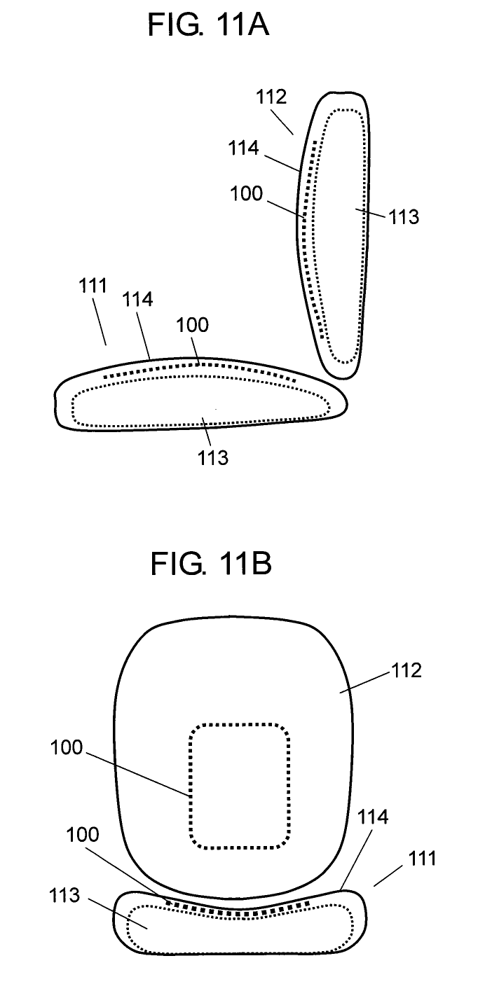

The above-described sheet heating element 100 is used, for example, in a car seat heater. In this case, as shown in FIGS. 11A and 11B, the sheet heating element 100 is attached to a seat part 111 and to a back rest 112 provided in a manner so as to rise from the seat part 111. The heating element 100 is attached so that the insulating substrate 101 is disposed on the surface side of the seat. The seat part 111 and the back rest 112 have a seat base material 113 and a seat cover 114 covering the seat base material 113. The seat base material 113 is formed from a flexible material such as a urethane pad and changes its shape when a load is applied by a seated person and regains its original shape when the load is removed. The sheet heating element 100 is attached with the polymer resistor 60 side facing the seat base material 113 and with the insulating substrate 101 facing the seat cover 114.

Since the sheet heating element 100 has a PTC characteristic, there is little energy consumed, since the temperature rises rapidly. A heating element without a PTC characteristic must additionally have a temperature controller. This additional temperature controller controls the heat-emitting temperature by turning the current on and off. In particular, when a heating element has line heat rays, there are several low-temperature sites between the linear heat rays. In order to reduce these low-temperature sites as much as possible, in the case of a heating element without a PTC characteristic, the heat-emitting temperature is raised to about 80° C. when ON. Thus, a heating element without a PTC characteristic must be disposed within a seat at some distance from the seat cover 114.

By contrast, in the case of the sheet heating element 100 which has a PTC characteristic, the heat-emitting temperature is automatically controlled so as to be in the range of 40° C.-45° C. Since the heat-emitting temperature is kept low in such a sheet heating element 100, it can be disposed close to the seat cover 114. Furthermore, since the heating element is disposed near the seat cover 114, it can rapidly convey heat to a seated passenger. Moreover, since the heat-emitting temperature is kept low, the energy consumption can be reduced.

The polymer resistor 60 according to the first embodiment is now described in further detail. A reactant resin formed from 30 parts ethylene/methyl acrylate copolymer (Sumitomo Chemical Co., Ltd. product “Akurifuto CM5021” with a melting point of 67° C.) and 30 parts ethylene/methacrylic acid copolymer (Mitsui-Dupont Polychemical Co. product “Nyukureru N1 560” with a melting point of 90° C.), and a liquid-resistant resin formed from 40 parts ionomer resin (Mitsui-Dupont Polychemical Co. product “Haimiran 1702” with a melting point of 90° C.) cross-linked by metallic ions between the molecules of an ethylene/methacrylic acid copolymer (metallic coordination compound) are mixed to form a resin compound formed from a reactant resin and a liquid-resistant resin. Since the above liquid-resistant resin has a carbonic acid functional group, it also functions as a reactive resin.

35 wt. % of this resin composition, 2 wt. % of a reactive resin (Sumitomo Chemical Co., Ltd. product “Bond First 7B”), 25 wt. % carbon black (Degussa product “Printex L” with a primary particle size of 21 nm) and 18 wt. % graphite (Nihon Kokuen product “GR15” flake graphite) as two types of conductors, and 20 wt. % flame retardant agent (Ajinomoto product “Reofos RDP” phosphoric acid ester-based liquid flame retardant), were mixed to produce a resistor composition 62.

Next, the resistor composition 65 was produced from 40 wt. % styrene-based thermoplastic elastomer (Asahi Kasei Engineering product “Tafutekku M1943”) as an elastomer, 45 wt. % carbon black (Mitsubishi Chemical product “#10B” with a primary particle size of 75 nm), and 13 wt. % tungsten carbide (Isawa Co. product), and 2 wt. % of a mixture of acrylic methacrylate/alkyl acrylate copolymer and ethylene tetrafluoride (Mitsubishi Rayon Co., Ltd. product “Metaburen A3000”).

Then, the resistor compositions 62 and 65 were mixed and kneaded with 2 wt. % of modified silicone oil as a mold release agent and 2 wt. % acrylic methacrylate/alkyl acrylate copolymer as a fluidity enhancer. These were then mixed with an apparatus such as a hot roller, kneader, biaxial kneader, or the like. This mixture was extruded from a T-die connected to an extruder, and formed into a film to produce the polymer resistor 60.

There are no particular restrictions on the thickness of the polymer resistor 60, but when flexibility, materials cost, appropriate resistance value, and strength when a load is applied are taken into consideration, a thickness of 20-200 micrometers is suitable, and preferably 30-100 micrometers.

Since the polymer resistor 60 is a flexible film, it stretches and changes its shape in the same manner as the insulating substrate 101 when an external force is applied to the sheet heating element 100. The polymer resistor 60 should be either as flexible as or more flexible than the insulating substrate 101. If the polymer resistor 60 is as flexible as or more flexible than the insulating substrate 101, then the durability and reliability of the polymer resistor 60 increases because the insulating substrate 101 has greater mechanical strength than the polymer resistor 60 and, when an external force is applied, serves to restrict a stretch or change of the shape of the polymer resistor 60.

It should be noted that the liquid-resistant polymer and the flame retardant agent can be added to the resistor composition 65, and they can be added in suitable amounts to both the resistor composition 62 and the resistor composition 65.

The pair of line electrodes 61A, 61B which are disposed facing each other are provided in two rows in the longitudinal direction of the sheet heating element 100. The polymer resistor 60 is arranged so as to overlap on the pair of line electrodes 61A, 61B, respectively. When electricity is supplied from the line electrodes 61A, 61B to the polymer resistor 60, current flows to the polymer resistor 60, and the polymer resistor 60 heats up.

The line electrodes 61 are sewn with a sewing machine onto the insulating substrate 101 with a polyester thread 102. Thus, the line electrodes 61 are firmly affixed to the insulating substrate 101, enabling it to change its shape as the insulating substrate 101 changes the shape, thereby increasing the mechanical reliability of the sheet heating element.

The line electrodes 61 are formed from at least either a metallic conductor wire and/or a twisted metallic conductor wires in which metallic conductor wires are twisted together. The metallic conductor wire material can be copper, tin-plated copper, or a copper-silver alloy. From the standpoint of mechanical strength, it is advantageous to use a copper-silver alloy because it has a high tensile strength. In detail, a line electrode 3 is formed by twisting together 19 copper-silver alloy wires with a diameter of 0.05 micrometers.

The resistance of the line electrodes 61 should be as low as possible, and the voltage drop along the line electrodes 61 should be small. The resistance of the line electrode 61 is selected so that the voltage drop of the voltage applied to the sheet heating element is 1 V or less. In other words, it is advantageous for the resistivity of the line electrode 61 to be 1 Ω/m or lower. If the diameter of the line electrodes 61 is large, it forms bumps in the sheet heating element 100, resulting in a loss of comfort when seated thereon. So the diameter should be 1 mm or less, and a diameter of 0.5 mm or less is desirable for an even more comfortable feeling when seated thereon.

A distance between the pair of line electrodes 61 should be in the range of about 70-150 mm. For practical purposes, the distance between the line electrodes 61 should be about 100 mm. If the distance between the electrodes is less than about 70 mm, when a person sits on the sheet heating element 1, and the buttocks are pressed on the line electrodes 61, there is a possibility that the load and flexural force will cause the line electrodes 61 to break or become damaged. On the other hand, if the distance between the electrodes is greater than 150 mm, the resistivity of the polymer resistor 60 must be reduced to a very low level, making it difficult to produce a useful polymer resistor 60 which has a PTC characteristic.

If the distance between the electrodes 61 is 70 mm, since the film thickness of the polymer resistor 60 is 20-200 micrometers as mentioned above, and preferably 30-100 micrometers, the resistivity of the polymer resistor 60 should be in the range of about 0.0016-0.016 Ω/m, and preferably about 0.0023-0.0078 Ω/m. Furthermore, if the distance between the line electrodes 61 is 100 mm, the resistivity of the polymer resistor 60 should be in the range of about 0.0011-0.011 Ω/m, and preferably about 0.0016-0.0055 Ω/m. Moreover, if the distance between the line electrodes 61 is 150 mm, the resistivity of the polymer resistor 60 should be in the range of about 0.0007-0.007 Ω/m, and preferably about 0.0011-0.0036 Ω/m.

It should be noted that in this embodiment, a line electrode is used as the electrode, but the present invention is not restricted thereto, and it is also possible to use a metallic foil electrode, or an electrode membrane produced by screen printing of a silver paste or the like.

A non-woven fabric formed from polyester fibers, punched using a needle punch, can be used for the insulating substrate 101. A woven fabric formed from polyester fibers can also be used. The insulating substrate 101 imparts flexibility to the sheet heating element 100. The sheet heating element 100 can easily change its shape if an external force is applied. So if it is used in a car seat heater, the feeling of comfort when seated thereon is improved. The sheet heating element has the same elongation properties as the seat cover material. Specifically, under a load of 7 kgf or less applied, it stretches by 5% at maximum.

As mentioned above, the line electrodes 61 are sewn onto the insulating substrate 101. Because of sewing, needle holes are formed in the insulating substrate 101, but the above-mentioned non-woven fabric or woven fabric can prevent cracks from developing from the needle holes.

Non-woven or woven fabrics of polyester fibers have good ventilation properties, and when used as a car seat heater or steering wheel heater, moisture will not collect. Thus, even if seated thereon or gripped for a long period of time, the initial comfortable feel is maintained and is very pleasant. And since no sound like sitting on paper is made when a passenger sits, the seat does not lose its comfortable feel even with the sheet heating element 100 placed inside.

The prior art sheet heating element was formed from a 5-6 layered structure involving a substrate, electrode, polymer resistor, hot-melt polymer, and a cover material. By contrast, the present invention sheet heating element 100 is formed from 3 layers, namely, the insulating substrate 101, the pair of line electrodes 61, and the polymer resistor 60. Since such a structure is simple, there are few structural elements that will be affected when an external force is applied. In other words, the sheet heating element 100 is more flexible than the prior art heating element. Therefore, if attached to a seat as a car seat heater, it will readily change the shape in response to an external force, and cracks and peeling of the polymer resistor due to wrinkles are prevented from occurring.

### Embodiment 2 of a Sheet Heating Element

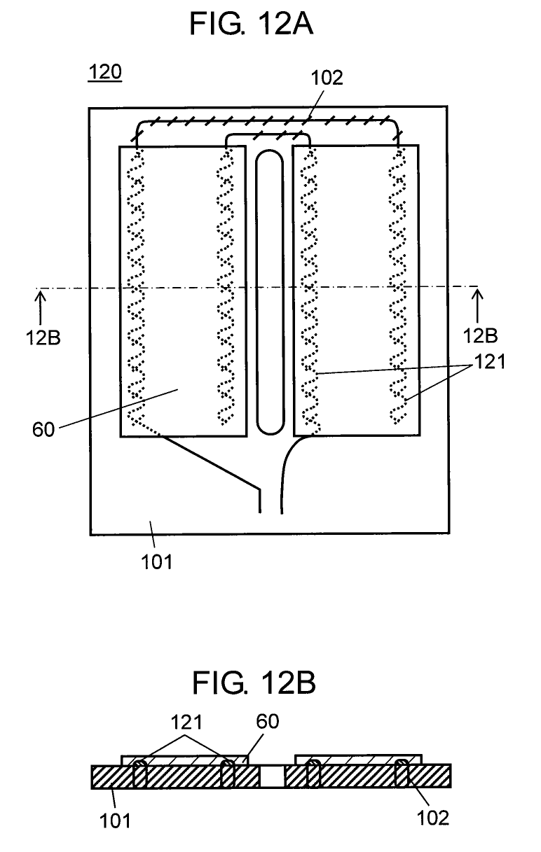

FIG. 12A is a plan view of the sheet heating element 120 of Embodiment 2 of the present invention, and FIG. 12B is a sectional view along the line 12B-12B in FIG. 12A. The structure differs from that of Embodiment 1 (see FIG. 10A, 10B) in that line electrodes 121 are arranged in wavy lines on the insulating substrate 101.

As shown in FIG. 12A, the line electrodes 121 are arranged in wavy lines on the insulating substrate 101, being attached by a thread 102. In accordance with this structure, when an external force is applied to the sheet heating element 120, since the line electrodes 121 are arranged in wavy lines, having leeway in terms of length, they readily change the shape in response to tension, stretching, and bending. Therefore, the wave line electrodes 121 have mechanical strength with respect to external force superior to that of the line electrodes 61.

Furthermore, in regions where the wave line electrodes 121 run, the voltage applied to the polymer resistor 60 becomes uniform, and the heating temperature distribution of the polymer resistor 5 becomes uniform.

### Embodiment 3 of a Sheet Heating Element

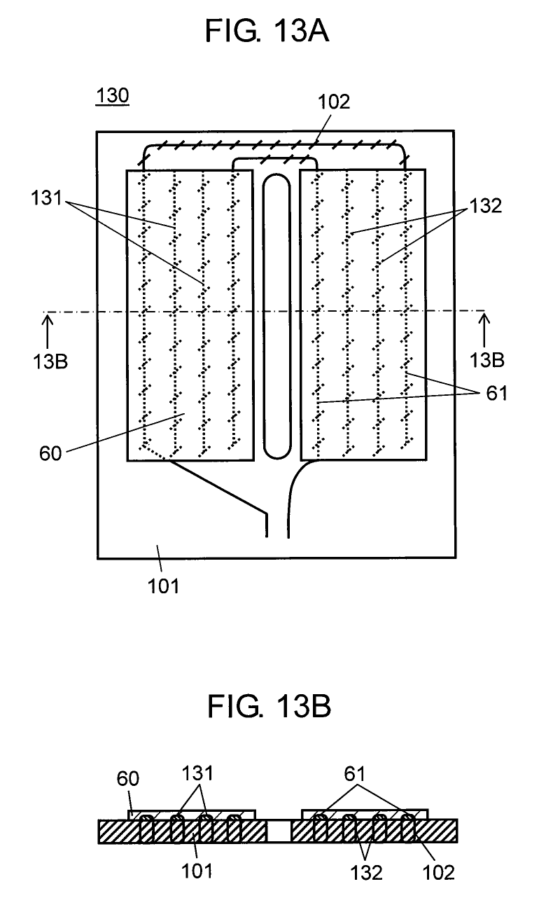

FIG. 13A is a plan view of the sheet heating element 130 of Embodiment 3 of the present invention, and FIG. 13B is a sectional view along the line 13B-13B in FIG. 13A. The structure differs from that of Embodiment 1 (see FIGS. 10A, 10B) in that auxiliary line electrodes 131 are arranged between the pair of line electrodes 61. In other words, auxiliary line electrodes 131 are arranged between the pair of line electrodes 61, and are sewn onto the insulating substrate 101 by sewing machine, using a thread 132 made of polyester fibers or the like, as in the case of the line electrodes 61.

In the structure shown in FIG. 10A, the polymer resistor 60 is prone to be unevenly heated between the line electrodes 61, and the resistivity for that portion rises, concentrating the electric potential there. If this state continues, temperature of that part of the polymer resistor 60 increases more than other parts, resulting in what is known as the hot-line phenomenon. By providing the auxiliary line electrodes 131 as in FIG. 13A, the electrical potential becomes uniform throughout the entire polymer resistor 60, so that the heating temperature becomes uniform. Consequently, the hot-line phenomenon can be prevented from occurring in the polymer resistor 60.

It should be noted that, like the line electrodes 61, the auxiliary line electrodes 131 are formed from a metallic conductor or twisted metallic conductors.

In FIG. 13A and FIG. 13B, two auxiliary line electrodes 131 are arranged between the pair of line electrodes 61. But the number of auxiliary line electrodes 131 is not restricted thereto, and the number can be determined according to the size of the polymer resistor 60, the distance between the line electrodes 61, and the required heat distribution.

In FIG. 13A, the auxiliary line electrodes 131 are arranged almost parallel to the pair of line electrodes 61. But the arrangement is not restricted thereto, and the auxiliary line electrodes 131 can also be arranged in a zig-zag configuration between the pair of line electrodes 61.

Moreover, the auxiliary line electrodes 131 can be arranged in a wavy configuration of the line electrodes 121 of Embodiment 2 as shown in FIGS. 12A and 12B. Of course, the wave-shaped line electrodes 121 and the wave-shaped auxiliary line electrodes 131 can be combined.

### Embodiment 4 of a Sheet Heating Element

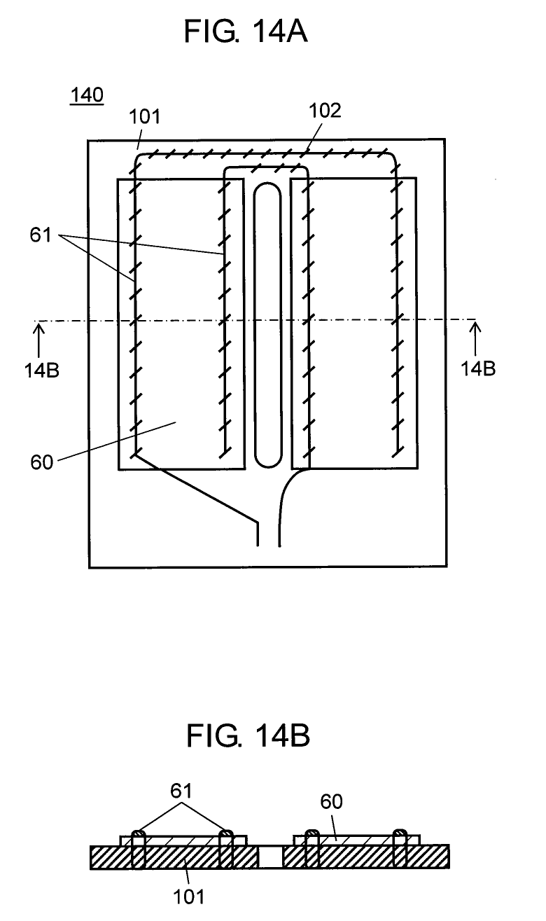

FIG. 14A is a plan view of a sheet heating element 140 of Embodiment 4 of the present invention. FIG. 14B is a sectional view along the line 14B-14B in FIG. 14A. The structure differs from that of Embodiment 1 (see FIGS. 10A, 10B) in that the polymer resistor 60 is disposed by inserting it between the insulating substrate 101 and the line electrodes 61.

The sheet heating element 140 of Embodiment 4 is produced as follows. First, the polymer resistor 60 is heat-laminated as a film on the insulating substrate 101. Then, the line electrodes 61 are arranged on the polymer resistor 60, and sewn by sewing machine on the insulating substrate 101. The line electrodes 61 and the polymer resistor 60 are subjected to thermal compression treatment, so that the line electrodes 61 adhere to the polymer resistor 60. Since the line electrodes 61 are on the polymer resistor 60, the arrangement position of the line electrodes 61 can be easily verified. When the central portion of the insulating substrate 101 is punched so as to increase the flexibility, punching of the line electrodes 61 can be reliably avoided.

Furthermore, since the line electrodes 61 are sewn onto the insulating substrate 101 to which the polymer resistor 60 has been attached, there is a greater degree of freedom in arranging the line electrodes 61. A variety of different sheet heating elements 140 can be easily produced by making the process of attaching the polymer resistor 60 to the insulating substrate 101 a shared process, after which the line electrodes 61 can be sewn in a variety of arrangements to have a variety of heating patterns.

Moreover, in this embodiment, it is also possible to provide the auxiliary line electrodes 131 shown in FIG. 13A.

In addition, in this embodiment, the line electrodes 61 and the polymer resistor 60 are thermally adhered. But the present invention is not restricted thereto. The line electrodes 61 and the polymer resistor 60 can also be adhered by using a conductive adhesive. The line electrodes 61 and the polymer resistor 60 can also be electrically connected by means of mechanical contact by simply pressing them together.

### Embodiment 5 of a Sheet Heating Element

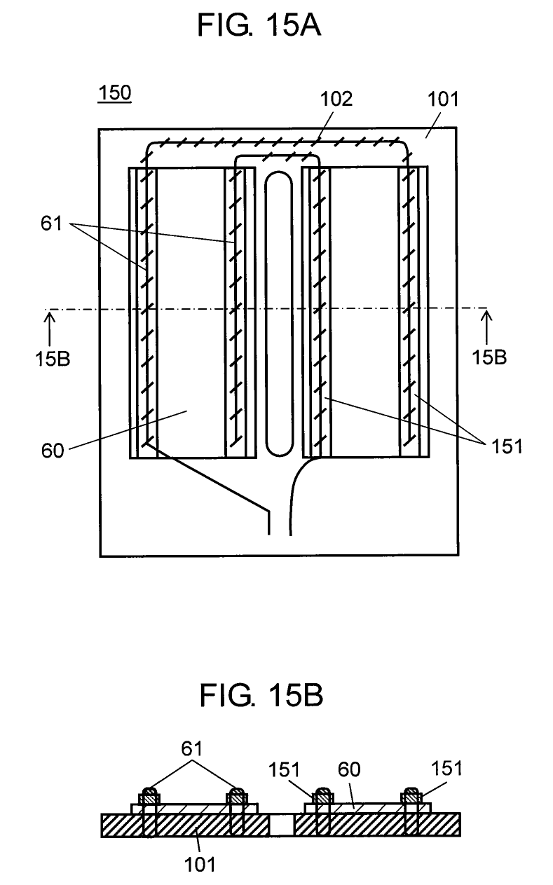

FIG. 15A is a plan view of a sheet heating element 150 of Embodiment 5 of the present invention. FIG. 15B is a sectional view along the line 15B-15B in FIG. 15A. The structure differs from that of Embodiment 4 (see FIGS. 14A, 14B) in that conductive strips 151 on which the line electrodes 61 are slidable are provided between the polymer resistor 60 and the line electrodes 61.

The sheet heating element 150 of Embodiment 5 is produced as follows. The polymer resistor 60 is heat-laminated as a film on the insulating substrate 101. After that, the conductive strips 151 are mounted on this polymer resistor 60. Then, the line electrodes 61 are arranged on the conductive strips 151 and sewn onto the insulating substrate 101 with a sewing machine. The line electrodes 61 and the polymer resistor 60 are subjected to thermal compression treatment, so that the polymer resistor 60 firmly adheres to the line electrodes 61.

The conductive strips 151 are formed, for example, from films produced from a dried graphite paste, or from films produced from a resin compound containing graphite. When the conductive strips 151 are mounted on the polymer resistor 60, these films are heat-laminated to the polymer resistor 60, or painted thereon.

Since the line electrodes 61 are slidable on the conductive strips 151, the flexibility of the sheet heating element 150 is increased further. Since the conductive strips 151 have excellent conductivity, the line electrodes 61 and the polymer resistor 60 are more reliably electrically connected via the conductive strips 151.

It should be noted that in this embodiment, it is also possible to additionally provide the auxiliary line electrodes 131 described in Embodiment 3 (see FIG. 13A). Moreover, the conductive strips 151 can also be provided for the auxiliary line electrodes 131.

In addition, in Embodiment 1 (see FIGS. 10A, 10B), if the conductive strips 151 are provided between the line electrodes 61 and the polymer resistor 60, a similar advantageous effect can be expected. In this case, the conductive strips 151 can be disposed in advance on in a position on the polymer resistor 60 facing the line electrodes 61.

In this embodiment, the conductive strips 151 are mounted on the polymer resistor 60 after adhering the polymer resistor 60 to the insulating substrate 101. The conductive strips 151 can be attached to the polymer resistor 60 in advance.

The line electrodes 61 and the polymer resistor 60 are thermally adhered. But the present invention is not restricted thereto. The line electrodes 61 and the polymer resistor 60 can also be adhered by using a conductive adhesive. The line electrodes 61 and the polymer resistor 60 can also be electrically connected by means of mechanical contact by simply pressing them together.

### Embodiment 6 of a Sheet Heating Element

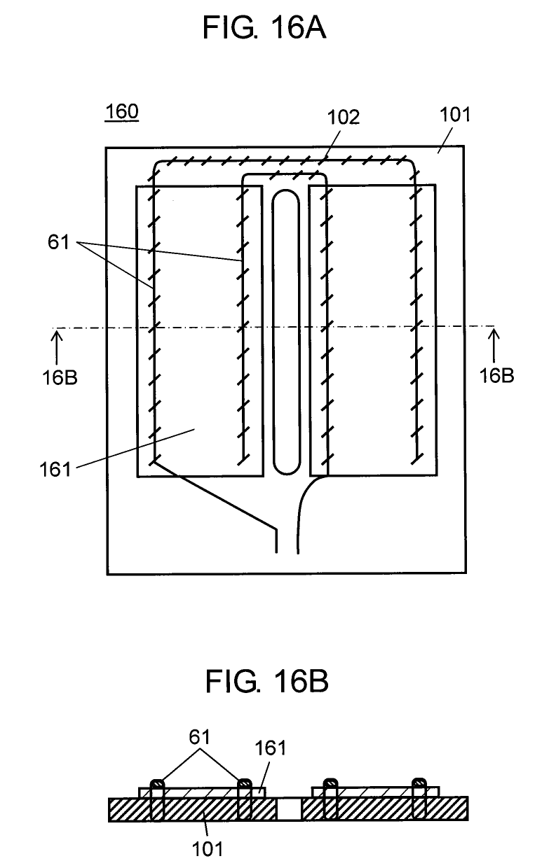

FIG. 16A is a plan view of a sheet heating element 160 of Embodiment 6 of the present invention. FIG. 16B is a sectional view along the line 16B-16B in FIG. 16A. The structure differs from that of Embodiment 4 (see FIGS. 14A, 14B) in that a polymer resistor 161 is provided instead of the polymer resistor 60. The polymer resistor 161 is produced by impregnating a meshed non-woven fabric or woven fabric with a polymer resistor.

The sheet heating element 160 of Embodiment 6 is produced as follows. An ink is produced by dispersing and mixing a polymer resistor described in Embodiments 1-5 in a liquid such as a solvent. A meshed non-woven fabric or woven fabric is impregnated with this ink by a method such as printing, painting, dipping, or the like, and then dried to produce the polymer resistor 161. The meshed non-woven fabric or woven fabric has a plurality of small pores between the fibers, and the resin resistor infiltrates into these pores.

Next, this polymer resistor 161 is adhered to the insulating substrate 101 by heat-lamination, after the line electrodes 61 are arranged on the polymer resistor 161, and sewn onto the insulating substrate 101 with a sewing machine. The line electrodes 61 and the polymer resistor 161 are subjected to thermal compression treatment, so that the polymer resistor 161 firmly adheres to the line electrodes 61.

In this structure, since the polymer resistor 161 is formed from a meshed non-woven or woven fabric having a plurality of pores, it exhibits a high degree of flexibility because it can easily change the shape under an external force acted thereupon.

Since the polymer resistor is held within the pores in the non-woven fabric or the woven fabric, the polymer resistor 161 closely adheres to the insulating substrate 101, thereby increasing the mechanical strength of the polymer resistor 161.

It should be noted that in this embodiment, a meshed non-woven fabric or woven fabric is impregnated with an ink-type polymer resistor. It is also possible to subject the meshed non-woven fabric or the woven fabric to thermal compression treatment to impregnate the non-woven fabric or the woven fabric with a film-type or sheet-type polymer resistor.

In addition, in this embodiment, the line electrodes 61 and the polymer resistor 161 are thermally adhered. But the present invention is not restricted thereto. The line electrodes 61 and the polymer resistor 161 can also be adhered by using a conductive adhesive. The line electrodes 61 and the polymer resistor 161 can also be electrically connected by means of mechanical contact by simply pressing them together.

Moreover, in this embodiment, it is also possible to provide the auxiliary line electrodes 131 described in Embodiment 3 (see FIG. 13A).

### Embodiment 7 of a Sheet Heating Element

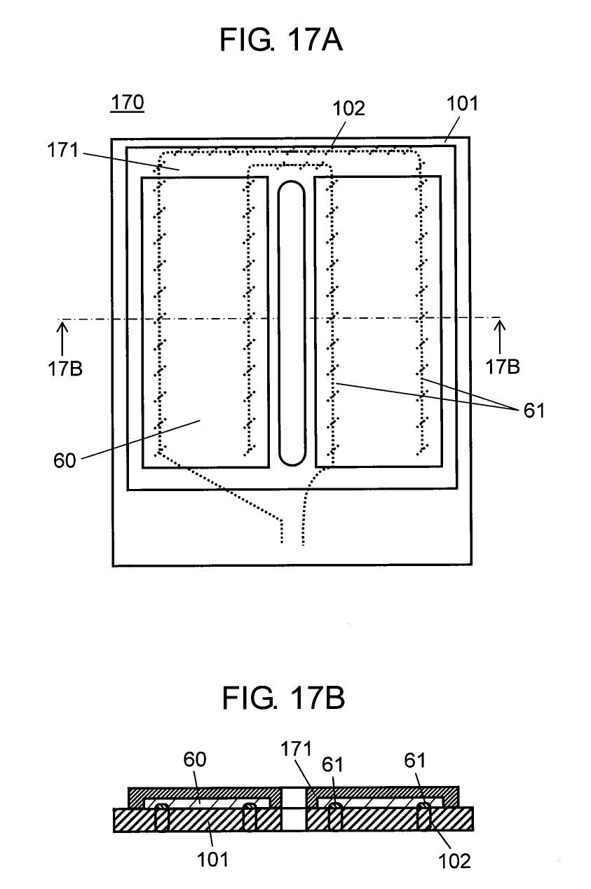

FIG. 17A is a plan view of a sheet heating element 170 of Embodiment 7 of the present invention. FIG. 17B is a sectional view along the line 17B-17B in FIG. 17A. The structure differs from that of Embodiment 1 (see FIGS. 10A, 10B) in that a cover layer 171 is further provided on the polymer resistor 60.

The cover layer 171 is formed from a material possessing electrical insulation properties. After using heat-lamination to laminate the polymer resistor 60 to the insulating substrate 101 to which the line electrodes 61 have already been attached, the cover layer 171 is also attached by heat-lamination, so as to cover the polymer resistor 60.

The cover layer 171 protects the sheet heating element 170 from impact and scratching which may damage the polymer resistor 60.

Furthermore, when the heating element is used in a car seat heater or such conditions as subjecting the heating element to a constant external force constant sliding, the cover layer 171 prevents abrasion of the polymer resistor 60, so the sheet heating element will not lose its heat-emitting function.

Moreover, since the sheet heating element 170 is electrically isolated, it is safe, even if high voltage is applied to the sheet heating element 170.

The cover layer 171 should be provided so as to cover the polymer resistor 60 in its entirety. However, keeping flexibility in mind, it is preferable to use a thin covering layer as the cover layer 171.

The cover layer 171 has as its primary component either a polyolefin-based thermoplastic elastomer, a styrene-based thermoplastic elastomer, or a urethane-based thermoplastic elastomer used by itself, or a combination thereof used as the primary component. The thermoplastic elastomer imparts flexibility to the sheet heating element 170.

It should be noted that the cover layer 171 can also be used in Embodiments 2-6 described above.

### Embodiment 8 of a Sheet Heating Element

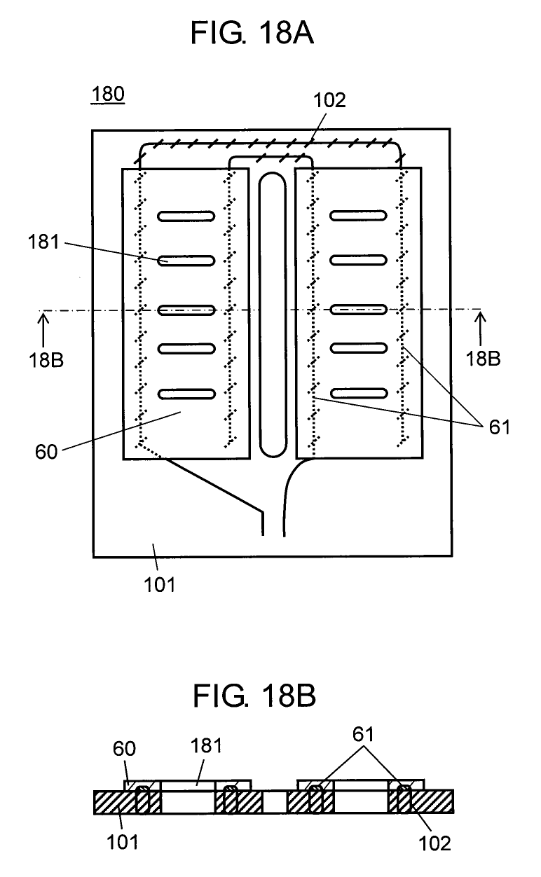

FIG. 18A is a plan view of a sheet heating element 180 of Embodiment 8 of the present invention. FIG. 18B is a sectional view along the line 18B-18B in FIG. 18A. The structure differs from that of Embodiment 1 (see FIGS. 10A, 10B) in that at least either the insulating substrate 101 and/or the polymer resistor 60 is provided with a plurality of slits 181.

The sheet heating element 180 of Embodiment 8 is produced as follows. First, as in Embodiment 1, the line electrodes 161 are arranged on the insulating substrate 101 and sewn thereon. Using T-die extrusion molding, the polymer resistor 60 is extruded as a film or sheet on the insulating substrate 101 and thermally adhered to the line electrodes 61 and the insulating substrate 101. After punching the central portion of the insulating substrate 101 to form elongated holes, a Thomson punch is used to form a plurality of slits 181 in the polymer resistor 60 and the insulating substrate 101.

The sites punched with a Thomson puncher are not restricted to the sites shown in the drawing. Depending on the shape of the seat cover 114, punching can be provided in places other than the sites shown in the drawing. In this case, it may be necessary to modify the wiring pattern of the line electrodes 61.

Furthermore, the line electrodes 61 and the polymer resistor 60 can be attached to the insulating substrate 101 on which have already been formed the slits 181 punched by a Thomson puncher. In the alternative, the polymer resistor 60 can be attached to a separator such as polypropylene or mold release paper (not shown). Then, the slits 181 are formed in the polymer resistor 60 by punching prior to attaching to the insulating substrate 101. In the former case, the slits 181 are formed only in the insulating substrate 101, and in the latter case, the slits 181 are formed only in the polymer resistor 60.

Since a plurality of slits 181 are formed in the sheet heating element 180 of this embodiment, the sheet heating element 180 can easily change the shape in response to an external force, so that the feeling of comfort is enhanced when seated thereon. Elongated hole formed in the central portion of the insulating substrate 101 may also be thought to serve to give flexibility to the sheet heating element 180. However, the elongated hole is provided to attach the sheet heating element 180 to the seat, and is not provided to give flexibility to the sheet heating element 180. Therefore, it has to be functionally distinguished from the slits 181.

It should be noted that the slits 181 of this embodiment can also be formed on the sheet heating elements of Embodiments 1-7.

### Embodiment 9 of a Sheet Heating Element

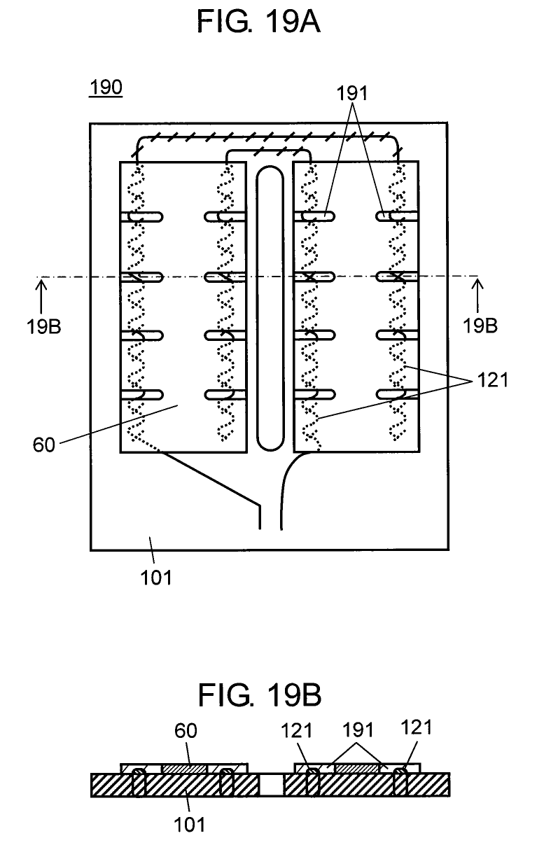

FIG. 19A is a plan view of a sheet heating element 190 of Embodiment 9 of the present invention. FIG. 19B is a sectional view along the line 19B-19B in FIG. 19A. The structure differs from that of Embodiment 8 (see FIGS. 10A, 10B) in that a plurality of notches 191 are provided, instead of the slits 181.

The sheet heating element 190 of Embodiment 9 is produced as follows. First, the polymer resistor 60 is attached to a separator such as polypropylene or mold release paper (not shown), and the polymer resistor 60 is punched to form the notches 191. Next, heat-lamination is used to attach the polymer resistor 60 to the insulating substrate 101 on which the wave-shaped line electrodes 121 have been arranged, after which the separator is removed from the polymer resistor 60.

In this configuration, the line electrodes 121 and the polymer resistor 60 are thermally adhered, so as to attach to each other firmly. Since the polymer resistor 60 easily changes the shape in response to an external force, due to the notches 191, the feeling of comfort is enhanced when seated thereon.

Moreover, similar notches 191 can be formed on the insulating substrate 101. In this case, these notches 191 serve the above-described function significantly, making it possible to further enhance the feeling of comfort when seated thereon.

The notches 191 of this embodiment can also be formed in the sheet heating elements of Embodiments 1-7.

It should be noted that the sheet heating elements described in Embodiments 2-9 can be attached so that the insulating substrate 101 is on the upper side if the seat part 111 and the back rest 112 shown in FIGS. 11A, 11B, as in the case of the sheet heating element 100 of Embodiment 1. The insulating substrate 101 serves as a cushion, and no bumps are formed on the surface due to the thickness and hardness of the line electrodes 61. Accordingly, there is no loss of comfort when seated or resting one's back.

### INDUSTRIAL APPLICABILITY

The sheet heating element of the present invention has a simple structure, an excellent PTC characteristic, and has flexibility in easily changing the shape in response to an external force. Since this sheet heating element can be attached to surfaces of appliances which have a complex surface topography, it can be used in heaters for car seats and steering wheels, and also in appliances such as electric floor heaters that require heat. Moreover, the range of application is extensive, because of excellent manufacturing productivity and cost reduction.

What is claimed is:

1. A PTC resistor comprising:
at least one PTC composition comprising at least one resin and at least two conductive materials, wherein the at least two conductive materials comprises at least two conductive materials different from each other.

2. A PTC resistor according to claim 1, wherein the at least one PTC composition comprises:
a first PTC composition comprising a first resin and at least one first conductive material; and
a second PTC composition compounded with the first PTC composition and comprising a second resin and at least one second conductive material,
wherein the at least one first conductive material is at least partially different from the at least one second conductive material.

3. A PTC resistor according to claim 2, wherein one of the first and second PTC compositions forms clusters which are distributed within the other of the first and second PTC compositions.

4. A PTC resistor according to claim 2, wherein one of the first and second PTC compositions is contained in the PTC resistor at a content of 20-80 wt. %.

5. A PTC resistor according to claim 2, wherein said one of the first and second PTC compositions is contained in the PTC resistor at a content of 30-70 wt. %.

6. A PTC resistor according to claim 2, wherein said one of the first and second PTC compositions is contained in the PTC resistor at a content of 40-60 wt. %.

7. A PTC resistor according to claim 2, wherein one of the first resin and the second resin comprises a reactant resin and a reactive resin which is cross-linked with the reactant resin.

8. A PTC resistor according to claim 7, wherein the reactant resin comprises a modified olefinic resin.

9. A PTC resistor according to claim 8, wherein the modified olefinic resin comprises ester-type ethylene copolymer.

10. A PTC resistor according to claim 9, wherein the ester-type ethylene copolymer comprises any one of ethylene/vinyl acetate copolymer, ethylene/ethyl acrylate copolymer, ethylene/methyl methacrylate copolymer, ethylene/methacrylic acid copolymer, and ethylene/butyl acrylate copolymer.

11. A PTC resistor according to claim 7, wherein the reactive resin is contained at a content of 1-20 wt. % in said one of the first resin and the second resin.

12. A PTC resistor according to claim 7, wherein the reactive resin is contained at a content of 1-10 wt. % in said one of the first resin and the second resin.

13. A PTC resistor according to claim 7, wherein the reactant and reactive resins contain different moieties selected from the group consisting of carboxyl groups, carbonyl groups, hydroxyl groups, ester groups, vinyl groups, amino groups, epoxy groups, oxazoline groups, and maleic anhydride groups.

14. A PTC resistor according to claim 7, wherein the first and second resins have an affinity to each other.

15. A PTC resistor according to claim 7, wherein the other of the first resin and the second resin comprises a moiety selected from the group consisting of carboxyl groups, carbonyl groups, hydroxyl groups, ester groups, vinyl groups, amino groups, epoxy groups, oxazoline groups and maleic anhydride groups.

16. A PTC resistor according to claim 2, wherein at least one of the first and second resins comprises a thermoplastic elastomer.

17. A PTC resistor according to claim 16, wherein the thermoplastic elastomer comprise at least one of an olefin-based thermoplastic elastomer, a styrene-based thermoplastic elastomer, a urethane-based thermoplastic elastomer, and a polyester-based thermoplastic elastomer.

18. A PTC resistor according to claim 16, wherein the thermoplastic elastomer is contained at a content of 5-20 wt. % in the at least one of the first and second resins.

19. A PTC resistor according to claim 2, wherein the at least one first conductive material contains at least one kind of conductive material which is not contained in the at least one second conductive material.

20. A PTC resistor according to claim 2, wherein the at least one first conductive material comprises carbon black, and the at least one second conductive material comprises graphite.

21. A PTC resistor according to claim 2, wherein the at least one first conductive material and the at least one second conductive material each comprise at least one of carbon black, graphite, carbon nanotubes, carbon fibers, conductive ceramic fibers, conductive whiskers, metal fibers, conductive inorganic oxides, and conductive polymer fibers.

22. A PTC resistor according to claim 2, wherein at least one of the at least one first conductive material and the at least one second conductive material is made in the form of flakes.

23. A PTC resistor according to claim 2, wherein at least one of the first and second resins comprise at least one of metal powder and conductive non-metallic powder.

24. A PTC resistor according to claim 2, wherein one of the at least one first conductive material and the at least one second conductive material is contained at a content of 30-90 wt. % in the first or second PTC composition which contains the at least one conductive material.

25. A PTC resistor according to claim 2, wherein one of the at least one first conductive material and the at least one second conductive material is contained at a content of 40-80 wt. % in the first or second PTC composition which contains the at least one conductive material.

26. A PTC resistor according to claim 2, wherein one of the at least one first conductive material and the at least one second conductive material is contained at a content of 60-70 wt. % in the first or second PTC composition which contains the at least one conductive material.

27. A PTC resistor according to claim 2, wherein the other one of the at least one first conductive material and the at least one second conductive material is contained at a content of 20-80 wt. % in the first or second PTC composition which contains the at least one conductive material.

28. A PTC resistor according to claim 2, wherein the other one of the at least one first conductive material and the at least one second conductive material is contained at a content of 30-70 wt. % in the first or second PTC composition which contains the at least one conductive material.

29. A PTC resistor according to claim 2 wherein the other one of the at least one first conductive material and the at least one second conductive material is contained at a content of 30-60 wt. % in the first or second PTC composition which contains the at least one conductive material.

30. A PTC resistor according to claim 2, wherein the PTC resistor has an electric resistivity ranging between 0.0007 Ω·m and 0.016 Ω·m.

31. A PTC resistor according to claim 2, wherein the PTC resistor has an electric resistivity ranging between 0.0011 Ω·m and 0.0078 Ω·m

32. A PTC resistor according to claim 2, wherein the PTC resistor exhibits an electric resistivity at 50° C. which is at least twice as high as the electric resistivity thereof measured at 20° C.

33. A PTC resistor according to claim 2, wherein at a temperature lower than 50° C., the PTC resistor exhibits an electric resistivity lower than an electric resistivity of either the first or second PTC composition, while at a temperature above 50° C., exhibiting an electric resistivity higher than those of the first and second PTC composition.

34. A PTC resistor according to claim 2, wherein the PTC resistor extends by more than 5% with a load of less than 7 kgf.

35. A PTC resistor according to claim 2, wherein the PTC resistor has a thermal expansion coefficient of between 20×10⁻⁵/K and 40×10⁻⁵/K.

36. A PTC resistor according to claim 2, wherein at least one of the first and second PTC compositions comprises a flame retardant agent.

37. A PTC resistor according to claim 36, wherein the flame retardant agent comprises at least one of a phosphorus-based flame retardant, a nitrogen-based flame retardant, a silicone-based flame retardant, an inorganic flame retardant and a halogen-based flame retardant.

38. A PTC resistor according to claim 36, wherein the PTC resistor satisfies at least one of the following conditions:
(a) When an end of the PTC resistor is burned with a gas flame, and the gas flame is extinguished after 60 seconds, the PTC resistor does not burn, even if the PTC resistor is charred;
(b) When an end of the PTC resistor is burned with a gas flame, the PTC resistor catches fire for no more than 60 seconds, but the flame extinguishes within 2 inches; or
(c) When an end of the PTC resistor is burned with a gas flame, even if the PTC resistor catches fire, the flame does not advance at a rate of 4 inches/minute or more in an area ½ inch thick from the surface.

39. A PTC resistor according to claim 36, wherein the flame retardant agent is contained in the PTC resistor at a content of 5 wt. % or more.

40. A PTC resistor according to claim 36, wherein the flame retardant agent is contained in the PTC resistor at a content of 10-30 wt. %.

41. A PTC resistor according to claim 36, wherein the flame retardant agent is contained in the PTC resistor at a content of 15-25 wt. %.

42. A PTC resistor according to claim 2, wherein the PTC resistor comprises a liquid-resistant resin.

43. A PTC resistor according to claim 42, wherein the liquid-resistant resin is contained at a content of 10 wt. % or more with respect to the first and second PTC compositions.

44. A PTC resistor according to claim 42, wherein the liquid-resistant resin is contained at a content of 10-70 wt. % with respect to the first and second PTC compositions.

45. A PTC resistor according to claim 42, wherein the liquid-resistant resin is contained at a content of 30-50 wt. % with respect to the first and second PTC compositions.

46. A PTC resistor according to claim 42, wherein the liquid-resistant resin comprises at least one of an ethylene/vinyl alcohol copolymer, a thermoplastic polyester resin, a polyamide resin, a polypropylene resin and an ionomer.

47. A PTC resistor according to claim 7, wherein the reactive resin comprises a liquid-resistant resin.
